(19) United States
(12) Patent Application Publication
(10) Pub. No.: US 2013/0101873 A1
(43) Pub. Date: Apr. 25, 2013

(54) METHOD AND SYSTEM FOR POWER GENERATION

(71) Applicants: Marc Dionne, Cochrane (CA); Leslie Frank Juhasz, Calgary (CA)

(72) Inventors: Marc Dionne, Cochrane (CA); Leslie Frank Juhasz, Calgary (CA)

(21) Appl. No.: 13/510,885

(22) PCT Filed: Nov. 17, 2010
(86) PCT No.: PCT/CA2010/001798

§ 371 Date: May 18, 2012

Related U.S. Application Data
(60) Provisional application No. 61/262,472, filed on Nov. 18, 2009.

(51) Int. Cl. H01M 8/06; H01M 8/24; H01M 16/00; F02B 63/04; G05F 1/10

(52) U.S. Cl. CPC H01M 8/0606; F02B 63/04; G05F 1/10; H01M 16/00; H01M 8/0618; H01M 8/24
USPC 429/9; 290/1 R; 307/151; 429/416; 429/423; 429/425; 429/452; 429/471

(57) ABSTRACT

A power generation systems with solid oxide fuel cell (SOFC) and heat recovery unit (HRU) and method are provided. In accordance with one embodiment of the disclosure, a power generation system includes a partial oxidation (POX) reactor, an array of one or more fuel cell stacks and an HRU. The POX reactor is operable to generate a hydrogen rich gas from a fuel. The array of one or more fuel cell stacks includes at least one SOFC and is coupled to the POX reactor. The fuel cell stacks are operable to generate electrical power and heat from an electro-chemical reaction of the hydrogen rich gas and oxygen from an oxygen source. The HRU is coupled to the array of fuel cell stacks and operable to generate electrical power from the heat.

### TECHNICAL FIELD

This invention relates to a power generation system and method, and more particularly to a Power Generation System with Solid Oxide Fuel Cell (SOFC) and Heat Recovery Unit (HRU) and Method.

### BACKGROUND

In populated areas, electricity is typically available through a power grid. However, in more remote areas, a power grid may not be available. For example, in remote areas where oil and gas exploration is occurring, electricity may be required to operate equipment, and a conventional source of electricity may not be available. An electrical generator can be used to produce electricity, for example, by using one or more motors to convert mechanical energy to electrical energy. Fuel cell technology uses an electrochemical reaction between a fuel and an oxidant in the presence of an electrolyte to produce electricity. A portable fuel cell power system can also be used to generate electricity, for example, in a location without access to a power grid or during times of a power grid outage.

### SUMMARY

Power generation systems and methods are described. In general, in one aspect, the invention features a power generation system with solid oxide fuel cell (SOFC) and heat recovery unit (HRU) and method. In accordance with one embodiment of the disclosure, a power generation system includes a partial oxidation (POX) reactor, an array of one or more fuel cell stacks and an HRU. The POX reactor is operable to generate a hydrogen rich gas from a fuel. The array of one or more fuel cell stacks includes at least one SOFC and is coupled to the POX reactor. The fuel cell stacks are operable to generate electrical power and heat from an electro-chemical reaction of the hydrogen rich gas and oxygen from an oxygen source. The HRU is coupled to the array of fuel cell stacks and operable to generate electrical power from the heat.

In particular embodiments, the POX reactor may be a catalytic partial oxidation (CPOx) reactor. The oxygen source may be preheated air and the fuel may be natural gas. Heat generated by the fuel cell stacks may include radiant heat from the stacks and heat from exhaust gases produced by the stacks. The POX reactor may also generate heat and the HRU may generate electrical power from heat from the POX reactor and the fuel cell stacks. In addition, a power conditioning unit may be provided to receive and condition electrical power from the fuel cell stacks and the HRU and to provide conditioned power to a load.

In accordance with another embodiment of the present disclosure, the power generation system may include any suitable reformer reactor operable to generate hydrogen rich gas from fuel. The reformer reactor may be, for example, a steam reformer, an auto thermal reformer (ATR) or a water-independent reformer. In still another embodiment, the POX reactor and/or reformer reactor may be omitted and a hydrogen rich gas source provided. The HRU may be, for example, a thermoelectric HRU or a Stirling engine HRU.

In accordance with another embodiment of the disclosure, a power generation system includes the partial oxidation (POX) reactor, an array of one or more fuel cell stacks and a power conditioning unit (PCU). The POX reactor is operable to generate a hydrogen rich gas from a fuel. The array of fuel cell stacks includes at least one SOFC and is coupled to the POX reactor. The array of fuel cells is operable to generate electrical power for a load from an electro-chemical reaction of the hydrogen rich gas and oxygen from an oxygen source. The PCU is operable to receive and condition electrical power from the array of fuel cell stacks and to provide at least 3 kilowatts (kW) power to the load.

In other embodiments of the present disclosure, the PCU may provide at least 5 kW of power to the load, 7 kW power to the load, or 10 kW power to the load. The array of fuel cell stacks may comprise 2, 4, 6, 8 or other suitable number of SOFC's.

In accordance with another aspect of the present disclosure, a power generation system may include a POX reactor and a plurality of fuel cell stacks arranged around the POX reactor. In this embodiment, the POX reactor may generate a hydrogen rich gas from a fuel. Each fuel cell stack may include at least one SOFC. The fuel cell stacks may be coupled to the POX reactor and operable to generate electrical power for a load from an electro-chemical reaction of the hydrogen rich gas and oxygen from an oxygen source.

In accordance with still another aspect of the present disclosure, a power generation system may include a POX reactor, a first heat exchanger disposed approximate to the POX reactor, a plurality of fuel cell stacks and a second heat exchanger proximate to the fuel cell stacks. The POX reactor is operable to generate hydrogen rich gas from a fuel. The first heat exchanger is operable to heat oxygen from an oxygen source to a first, intermediate or other suitable level. The fuel cell stacks include at least one SOFC and are arranged around the POX reactor. The second heat exchanger is operable to heat the oxygen source from the intermediate level to an operational or other suitable level for the fuel cell stacks. The fuel cell stacks may be coupled to the POX reactor and operable to generate electrical power for a load from an electro-chemical reaction of the hydrogen rich gas and the oxygen heated to the operational level.

In general, in another aspect, the invention features a power generation system including a POX reactor, an array of one or more fuel cell stacks and a control unit. The POX reactor is operable to generate a hydrogen rich gas from a fuel. Each fuel cell stack includes at least one solid oxide fuel cell (SOFC). The array is coupled to the POX reactor and operable to generate electrical power for a load from an electro-chemical reaction of the hydrogen rich gas and oxygen from an oxygen source. The control unit is operable to control a feed of hydrogen rich gas and a feed of oxygen to the array of fuel cell stacks to maintain a substantially constant output of power from the array of fuel cell stacks for at least 18 months.

Implementations of the system can include one or more of the following features. The POX reactor can be a catalytic partial oxidation (CPOx) reactor.

The control unit can be further operable to monitor a voltage output from the array of fuel cell stacks and to control the feed of hydrogen rich gas based on the monitored voltage output to maintain the substantially constant output of power. The control unit can be further operable to monitor a current output from the array of fuel cell stacks to control the feed of oxygen based on the monitored current output to maintain the substantially constant output of power. The control unit can be further operable to control a feed of hydrogen rich gas and a feed of oxygen to the array of fuel cell stacks to maintain a substantially constant output of power from the array of fuel cell stacks for at least 18 months.

The power generation system can further include a heat recovery unit (HRU) coupled to the array of fuel cell stacks. The HRU can be operable to generate electrical power from heat recovered from the array of fuel cell stacks. Heat recovered from the array of fuel cell stacks can include radiant heat generated by the one or more fuel cell stacks and heat from exhaust gases produced by the one or more fuel cell stacks. The POX reactor can generate heat and the HRU can be further operable to recover heat from the array of fuel cell stacks and the POX reactor and to generate electrical power from the recovered heat.

The fuel can be, for example, methane, natural gas or propane. The array of fuel cell stacks can include a plurality of fuel cell stacks and the POX reactor can be positioned within a thermal zone of the plurality of fuel cell stacks. The oxygen source can be air.

The power generation system can further include a power conditioning unit (PCU) operable to receive and condition electrical power from the array of fuel cell stacks and to provide the conditioned power to a load. The power generation system can further include a heat recovery unit (HRU) coupled to the array of fuel cell stacks. The HRU can be operable to generate electrical power from heat recovered from the array of fuel cell stacks. The PCU can be operable to receive and condition electrical power received from the array of fuel cell stacks and the HRU.

In general, in another aspect, the invention features a power generation system including a reformer reactor, an array of one or more fuel cell stacks and a controller. The reformer reactor is operable to generate a hydrogen rich gas from a fuel. Each fuel cell stack includes at least one electro-chemical fuel cell. The array is coupled to the reformer reactor and operable to generate electrical power and heat from an electro-chemical reaction of the hydrogen rich gas and oxygen from an oxygen source. The controller is operable to purge the reformer reactor and the array of fuel cell stacks with accumulated nitrogen to inhibit oxidation and the formation of nickel carbonyl on a catalyst in the reformer reactor and one or more fuel cells in the array of fuel cell stacks.

Implementations of the power generation system can include one or more of the following features. The power generation system can further include a heat recovery unit (HRU) coupled to the array of fuel cell stacks. The HRU can be operable to generate electrical power from the heat recovered from the array of fuel cell stacks. The controller can be further operable to direct electrical power from the HRU to the array of fuel cell stacks during a shutdown operation to inhibit oxidation in the array of fuel cell stacks. Heat recovered from the array of fuel cell stacks can include radiant heat generated by the one or more fuel cell stacks and heat from exhaust gases produced by the one or more fuel cell stacks. The reformer reactor can generate heat and the HRU can be further operable to recover heat from the array of fuel cell stacks and the reformer reactor and to generate electrical power from the recovered heat.

The HRU can be a thermoelectric HRU, a microturbine HRU, a Stirling engine HRU or a Rankine cycle HRU, to name some examples. The reformer reactor can be a water-independent reformer reactor, e.g., a partial oxidation (POX) reactor or a catalytic partial oxidation (CPOx) reactor or a steam reformer or an autothermal reformer. The electro-chemical fuel cell can be a solid oxide fuel cell (SOFC) or a high temperature ceramic fuel cell, to name a couple of examples. The fuel can be natural gas, methane or propane, to name a couple of examples.

The array of fuel cell stacks can include a plurality of fuel cell stacks and the reformer reactor can be positioned within a thermal zone of the plurality of fuel cell stacks. The oxygen source can be air. The power generation system can further include a power conditioning unit (PCU) operable to receive and condition electrical power from the array of fuel cell stacks and to provide the conditioned power to a load.

In general, in another aspect, the invention features a power generation system including a reformer reactor, an array of one or more fuel cell stacks, a heat source and a heat recovery unit (HRU). The reformer reactor is operable to generate a hydrogen rich gas from a fuel. Each fuel cell stack includes at least one electro-chemical fuel cell. The array is operable to generate electrical power and heat from an electro-chemical reaction of the hydrogen rich gas and oxygen from an oxygen source. The heat source is operable to warm the array of fuel cell stacks during a start-up operation. The HRU is operable to generate electrical power from heat generated by the reformer reactor and the heat source within approximately 30 minutes of commencing the start-up operation.

Implementations of the power generation system can include one or more of the following features. The HRU can be further operable to generate electrical power from the heat generated by the reformer reactor and the heat source within approximately 30 minutes of commencing the start-up operation. The reformer reactor can be a partial oxidation (POX) reactor, which in one example is a catalytic partial oxidation (CPOx) reactor. The heat source can be a battery operated heater, a gas-operated heater and/or can include heat generated by the reformer reactor. The fuel can be natural gas, methane or propane. The HRU can be a thermoelectric HRU, a microturbine HRU, a Stirling engine HRU or a Rankine cycle HRU. The electro chemical fuel cell can be a solid oxide fuel cell (SOFC) or a high temperature ceramic fuel cell. The oxygen source can be air. The power generation system can further include a power conditioning unit (PCU) operable to receive and condition electrical power from the array of fuel cell stacks and HRU and to provide the conditioned power to a load.

In general, in another aspect, the invention features a power generation system including a reformer reactor, an array of one or more fuel cell stacks and a heat recovery unit (HRU). The reformer reactor is operable independent of water to generate a hydrogen rich gas from a fuel. Each fuel cell stack includes at least one electro-chemical fuel cell. The array is coupled to the reformer reactor and operable to generate electrical power and heat from an electro-chemical reaction of the hydrogen rich gas and oxygen from an oxygen source. The HRU is coupled to the array of fuel cell stacks and operable to generate electrical power from the heat generated by the array of fuel cell stacks.

Implementations of the power generation system can include one or more of the following features. The reformer reactor can be a partial oxidation (POX) reactor or a catalytic partial oxidation (CPOx) reactor. The heat generated by the array of fuel cell stacks can include radiant heat generated by the one or more fuel cell stacks and heat from exhaust gases produced by the one or more fuel cell stacks. The reformer reactor can generate heat and the HRU can be further operable to recover heat from the array of fuel cell stacks and the reformer reactor and to generate electrical power from the recovered heat. The array of fuel cell stacks can include a plurality of fuel cell stacks and the reformer reactor can be positioned within a thermal zone of the plurality of fuel cell stacks. The at least one electro-chemical fuel cell can include a solid oxide fuel cell (SOFC). The power generation system can further include a power conditioning unit (PCU) operable to receive and condition electrical power from the array of fuel cell stacks and the HRU and to provide the conditioned power to a load. The fuel can be natural gas, methane or propane. The oxygen source can be air. The HRU can be a thermoelectric HRU, a microturbine HRU, a Stirling engine HRU or a Rankine cycle HRU.

In general, in another aspect, the invention features a power generation system including a reformer reactor operable to generate a hydrogen rich gas from a fuel, an array of one or more fuel cell stacks, a heat recovery unit (HRU) and a controller. Each fuel cell stack includes at least one electro-chemical fuel cell. The array is coupled to the reformer reactor and operable to generate electrical power and heat from an electro-chemical reaction of the hydrogen rich gas and oxygen from an oxygen source. The HRU is coupled to the array of fuel cell stacks and operable to generate electrical power from the heat generated by the array. The controller is operable to control operation of the power generation system. The controller includes a self-diagnostic unit operable to detect a fault and to communicate the fault over a network to a remote location.

Implementations of the power generation system can include one or more of the following features. The heat generated by the array of fuel cell stacks can include radiant heat generated by the one or more fuel cell stacks and heat from exhaust gases produced by the one or more fuel cell stacks. The reformer reactor can generate heat and the HRU can be further operable to recover heat from the array of fuel cell stacks and the reformer reactor and to generate electrical power from the recovered heat. The electrical power output from the array of fuel cell stacks and the HRU can be in the range of approximately 3 to 10 kilowatts. The fault can be related to at least one of the following: a load on the power generation system, a current generated by the power generation system, a voltage generated by the power generation system, a flow rate of the fuel, a flow rate of the oxygen, a temperature measured within the power generation system, or a pressure measured within the power generation system.

The network can be a telephone network, a radio network or a satellite network. The power generation system can further include one or more sensors that are operable to communicate with the self-diagnostic unit. The one or more sensors can be wireless sensors. The power generation system can further include a remote control unit, where the remote control unit is operable to: communicate with the controller over the network; and transmit instructions to control operation of the power generation system to the controller over the network. The power generation system can further include a power conditioning unit (PCU) operable to receive and condition electrical power from the array of fuel cell stacks and the HRU and to provide the conditioned power to a load.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a schematic block diagram of an example power generation system.

FIGS. 1B-D are graphs illustrating the relationship between power generation and current in the example power generation system of FIG. 1A.

FIG. 2 is a schematic representation of an example reformer reactor.

FIG. 3A is a schematic representation of a simplified example fuel cell.

FIG. 3B is a schematic representation of an example fuel cell stack.

FIGS. 3C and 3D are schematic representations of an alternative example fuel cell stack.

FIG. 4 is a schematic representation of an example heat recovery unit.

FIG. 5 is a schematic representation of an example power conditioning unit.

FIGS. 6A-B are schematic block diagrams of specific embodiments of a power generation system.

FIGS. 7A-C show different views of the power generation system of FIG. 6 as configured in a portable power generation unit.

FIG. 8 is a flow diagram illustrating an example method of operating a power generation system.

FIG. 9 is a flow diagram illustrating an example method for performing the start-up mode of FIG. 8.

FIG. 10 is a flow diagram illustrating an example method for performing the pre-run mode of FIG. 8.

FIG. 11 is a flow diagram illustrating an example method for performing the run mode of FIG. 8.

FIG. 12 is a flow diagram illustrating an example method for performing the shut-down mode of FIG. 8.

Like reference symbols in the various drawings indicate like elements.

### DETAILED DESCRIPTION

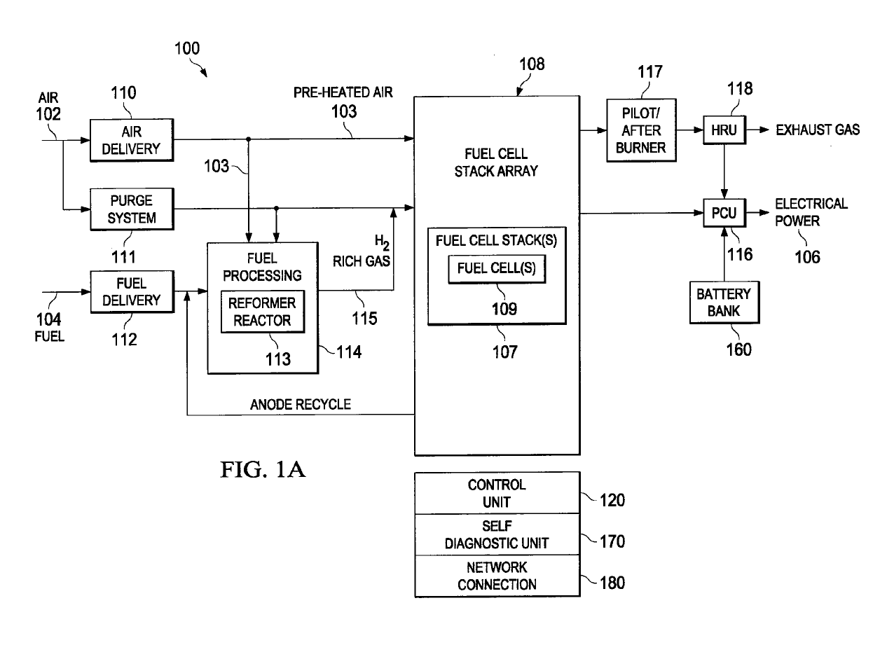

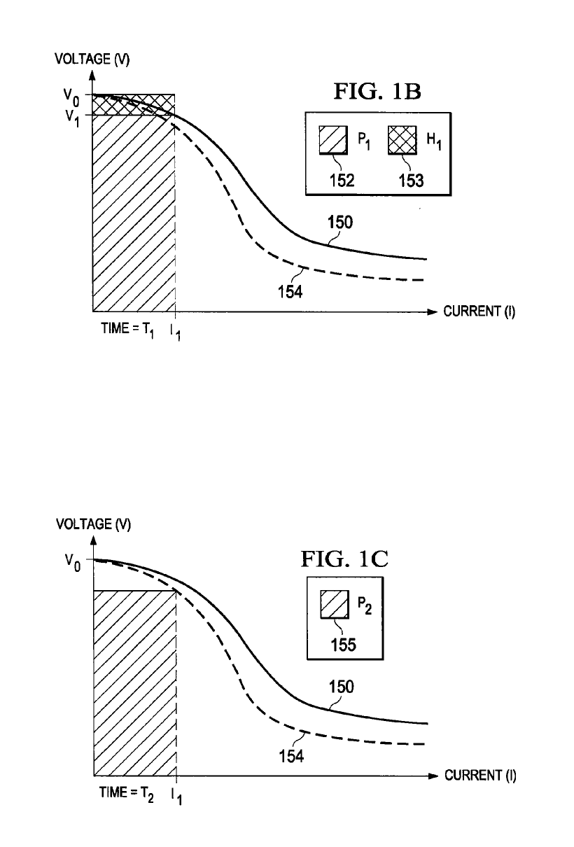

FIG. 1A is a schematic representation of an example implementation of a power generation system 100. A source of oxygen, which in this implementation is air 102, and fuel 104 are inputs into the system 100 and electrical power 106 is an output of the system 100. A fuel cell stack array 108 generates the electrical power 106 and waste heat from an electro-chemical reaction of the air 102 and fuel 104. The fuel cell stack array 108 can include one or more fuel cell stacks 107, where each fuel cell stack includes one or more fuel cells 109.

The air 102 is input into an air delivery system 110 coupled to the fuel cell stack array 108. The air delivery system 110 is operable to preheat the air to a suitable temperature for delivery to the fuel cell stack array 108 to avoid thermally shocking the one or more fuel cells 109 included in the array. For example, where each fuel cell stack 107 includes one or more ceramic fuel cells, a thermal shock to the stack 107 can crack the ceramic plate included in the fuel cell 109. The air is preferably pre-heated to just below the operating temperature of the fuel cell stack array 108. In some implementations, the air delivery system 110 includes one or more heat exchangers arranged in series. The heat exchangers can be coil exchangers, shell and tube and/or plate and fin exchangers, or otherwise configured. It should be noted that although in the example implementation shown, pre-heated air 103 is input into the fuel cell stack array 108, in other implementations an oxygen source other than air can be used, for example, pure oxygen.

In the implementation shown, the fuel 104 is input into a fuel delivery system 112. The fuel delivery system 112 can include one or more pressure drop down valves for pressure reduction, for example, if the fuel is being received from a pipeline at a relatively high pressure. In some implementations, the fuel delivery system 112 includes a desulphurizer. For example, if the fuel 104 is natural gas, the desulphurizer can be used to remove mercaptan added to the natural gas to provide an odor.

The fuel is delivered to a fuel processing system 114. The fuel processing system 114 includes a reformer reactor 113 operable to generate a hydrogen rich gas 115 from the fuel 104. In some implementations, the reformer reactor 113 is a partial oxidation (POx) reformer. In a particular example, the reformer reactor is a catalytic partial oxidation reformer (CPOx).

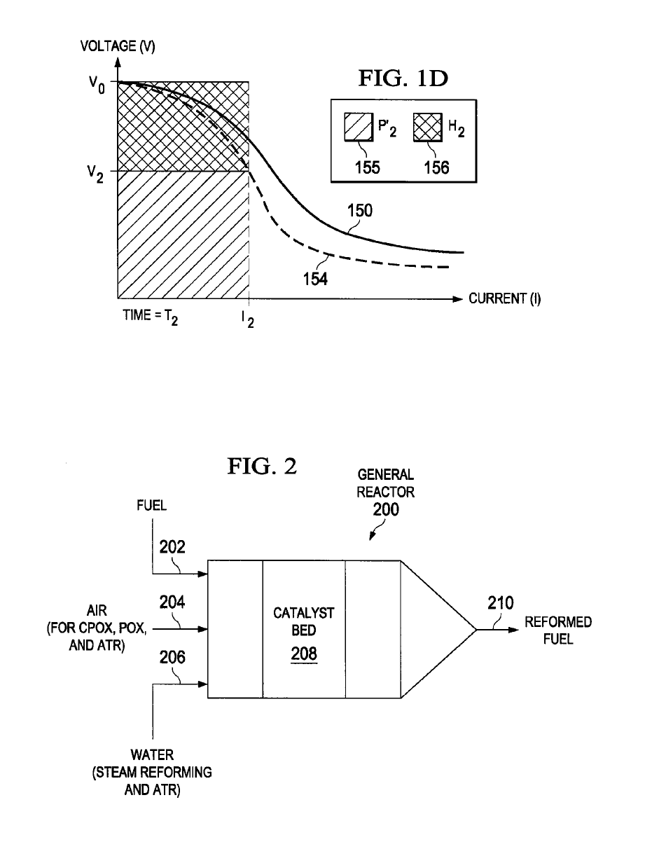

Referring to FIG. 2, a schematic representation of an example reformer reactor 200 is shown for illustrative purposes. Examples of different reformer reactors that can be used include a Partial Oxidation reactor (POx) (e.g., a Catalytic Partial Oxidation reactor (CPOx)), a Steam Methane Reformer (SMR) an Auto Thermal Reactor (ATR) and Prereformer (PR). Inputs to the reformer reactor depend on the type of reformer reactor. For example, POx and CPOx reformer reactors have fuel 202 and air 204 as inputs. An ATR reformer reactor has fuel 202, air 204 and water 206 as inputs. An SMR reformer reactor has fuel 202 and water 206 as inputs. The reformer reactor is used for converting hydrocarbon gases (e.g., natural gas, methane or propane) to a hydrogen and carbon monoxide rich stream, i.e., reformate 210. These two gas species are consumed by oxygen within fuel cell stacks to produce electricity. The fuel conversion can be performed within the reformer reactor by either a water gas shift reaction or partial oxidation reactions. The reformer reactor 200 includes a catalyst bed 208 which can selectively enhance the chemical conversion to hydrogen and carbon monoxide. In some implementations, some of the fuel 104 passes through the reformer reactor 200 without being converted and is input to the fuel cell stack array 108 unconverted (e.g., as methane if methane is the fuel), where it is converted with the fuel cell stacks.

Referring again to FIG. 1A, the reformer reactor 113 can reform a fuel 104 of natural gas into a hydrogen rich gas 115 including hydrogen (H₂) and carbon monoxide (CO). By way of example, the hydrogen rich gas 115 can be approximately 53% hydrogen. As discussed above, configurations of reformer reactor 113 other than POx reactor can be used, for example, an autothermal reformer (ATR) or a steam methane reformer (SMR). The selection of reformer reactor can depend on the application for which the power generation system is being used. For example, an autothermal reformer and a steam reformer both use water, and are therefore not preferred for use in an environment having ambient temperatures substantially below freezing. By contrast, the POx or CPOx reformer, or another type of water-independent reformer, are preferred for such an environment, since concerns about freezing the water required to operate the reformer reactor can be eliminated.

In an implementation where the reformer reactor 113 is exothermic, for example, a CPOx reformer, waste heat generated by the reformer reactor can be used to provide heat to a heat exchanger included in the air delivery system 110. For example, a CPOx reformer typically has a cylindrical shape, and a heat exchanger can be wrapped around the exterior of the CPOx reformer and thereby heat the air 102, at least in part, using the waste heat generated by the CPOx reformer.

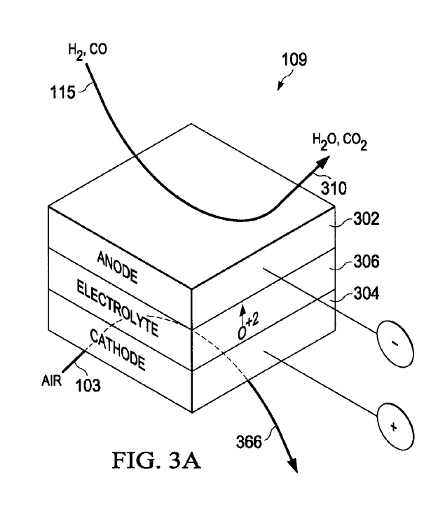

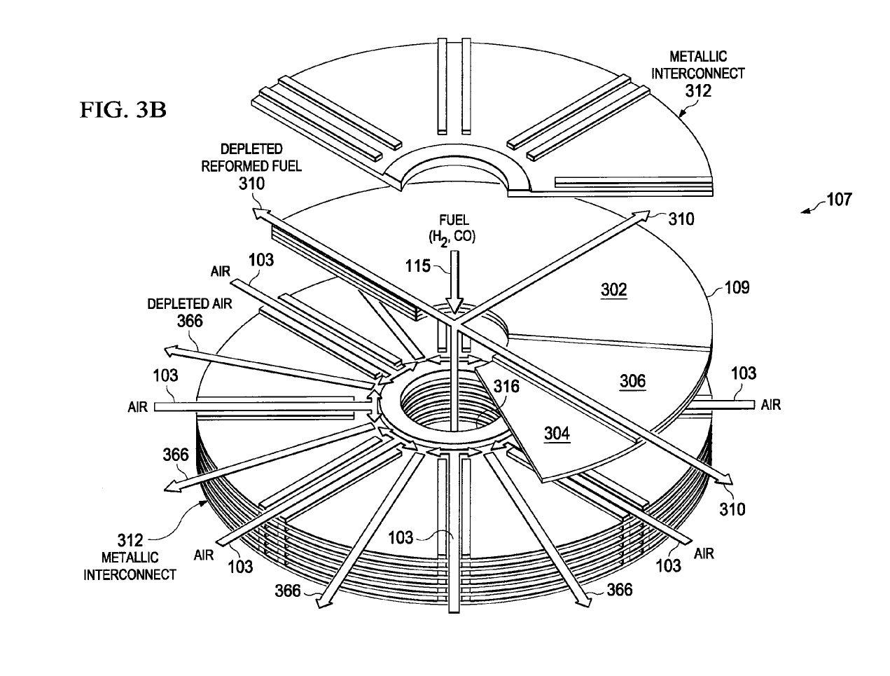

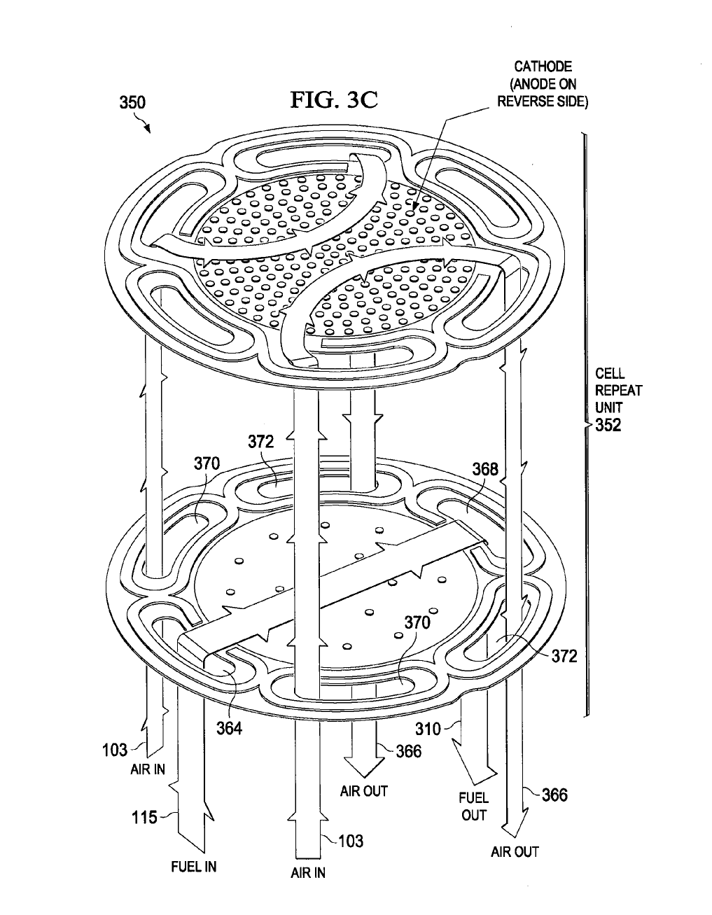

The pre-heated air 103 and the hydrogen rich gas 115 are input to the fuel cell stack array 108, which includes one or more fuel cell stacks 107. As discussed above, in some implementations, some unconverted fuel (e.g., methane if methane was the fuel input into the reformer reactor) is also an input to the fuel cell stack array 108. Each fuel cell stack includes one or more fuel cells 109, and is an electrochemical conversion device operable to generate electrical power from fuel and oxygen, in this implementation, the hydrogen rich gas 115 and the pre-heated air 103. Referring to FIG. 3A, a schematic representation of a simplified fuel cell 109 is shown for illustrative purposes. Generally, a fuel cell includes an anode 302 and a cathode 304 separated by an electrolyte 306. The hydrogen rich gas 115 is supplied to the anode 302. The air 103 reacts with the cathode 304 and separates into two charged oxygen ions. The oxygen ions migrate across the electrolyte 306 and react with the hydrogen and the carbon monoxide (also included in the hydrogen rich gas) to form water and carbon dioxide 310. The electrons from the oxygen atoms build up a negative charge in the cathode 304 creating an electrical current from cathode to anode.

There are different types of fuel cells and they are typically classified by the electrolyte used in the fuel cell. A solid oxide fuel cell (SOFC) typically uses a ceramic material as an electrolyte The power generation system 100 can use different types of fuel cells, including without limitation the following: SOFC, and protonic ceramic fuel cells (PCFCs).

Referring to FIG. 3B, a schematic representation is shown of an example implementation of a fuel cell stack 107 in a cylindrical form with an afterburning zone at the stack perimeter. Note that a fuel cell stack 107 may be of circular, rectangular or other polygonal cross section with similar operating features. The fuel cell stack 107 includes multiple fuel cells, in this example, each fuel cell is a SOFC having a planar ceramic unit that includes the anode 302, cathode 304 and electrolyte 306. A metallic interconnect 312 is a metallic collector of the electrical power generated by the fuel cells 109. The metallic interconnect 312 is also constructed planar. Both the ceramic unit and the metallic interconnect 312 include an aperture in the middle forming a channel 316 for the fuel supply, i.e., the hydrogen rich gas 115. In the example stack 107 shown, there are seven SOFCs stacked on one another. In practice, the number of SOFCs included in a fuel cell stack can vary, depending on the power output requirements, for example, 60 SOFCs can be used to supply an output electrical power of 1 kW for a typical thermal input of about 2.5 kW

The metallic interconnect 312 ensures the electrical contact between the individual SOFCs 109 included in the stack 107. The metallic interconnect 312 is further operable to distribute gases on the surface of the electrode, seal the gas flow against the air flow and enable the afterburning zone at the stack perimeter fluidically. The hydrogen rich gas 115 flows radially out of the channel at the anode end of the SOFCs towards the outside. By the time the gas 115 reaches the outside perimeter, the gas is hydrogen depleted gas 310. Simultaneously, the preheated air 103 flows from the outside into the interior of the stack through channels on the metallic interconnect 312 (in this example, eight channels) and is redirected in order to flow radially over the cathode end of the SOFCs to the outside (exiting as 366). Hydrogen rich gas 115 that is not converted on the anode 302 can be afterburned at the edge of the fuel cell 109. Preheated air 103 that is not converted on the cathode 304 can be afterburned at the edge of the fuel cell 109. The afterburning of the fuel and air occurs around the perimeter of the entire fuel cell stack 107.

Referring to FIGS. 3C and 3D, a schematic representation is shown of another example implementation of a fuel cell stack 350, which can be used as the fuel cell stack 107 in the system 100. The fuel cell stack 350 is in a cylindrical form with internal ducting to a separate afterburner component 117 external to the fuel cell stack 350. Note that the fuel cell stack 350 may be of circular, rectangular or other polygonal cross section with similar operating features as indicated in the differences between FIGS. 3C and 3D. The fuel cell stack 350 includes multiple fuel cells, in this example, each fuel cell is a SOFC having a planar ceramic unit that includes the anode 356, cathode 360 and electrolyte 358. A metallic interconnect 354 is a metallic collector of the electrical power generated by the fuel cells 352. The metallic interconnect 354 is also constructed planar. Both the ceramic unit (i.e., 356, 358, 360) and the metallic interconnect 354 include apertures at the edges forming a channel 364 for the fuel supply, e.g., a hydrogen rich gas 115; a channel 368 for the outlet fuel 310; a channel 370 for the preheated air 103; and a channel 372 for the outlet air 366. In the example stack 350 shown, there is one SOFC repeating cell unit 352 shown. In practice, the number of SOFCs included in a fuel cell stack can vary, depending on the power output requirements, for example, 60 SOFCs can be used to supply an electrical power of 1 kW for a thermal input of about 2.5 kW.

The fuel cell stack output can vary in different implementations and can be, for example, 1 kW, 3 kW or 10 kW (although other outputs are possible). Depending on which fuel cell stack is used, the number of stacks in the system can vary.

The metallic interconnect 354 provides an electrical contact between the individual SOFCs 352 included in the stack 350. The metallic interconnect 354 is further operable to distribute gases on the surface of the electrode, seal the gas flow against the air flow and enable the collection and ducting of the depleted outlet fuel and the depleted outlet air to the afterburner 117. The hydrogen depleted gas 310 flows out of the channel 368 at the anode end of the SOFC stack 350 to the collection manifold and then to an afterburner. Simultaneously, the preheated air 103 flows from the outside into the interior of the stack through channels 370 on the metallic interconnect 354 and is redirected in order to flow over the cathode end of the SOFCs to the collection manifold and then to the afterburner 117. Hydrogen rich gas 115 that is not converted on the anode 356, and preheated air 103 that is not converted on the cathode 360, can be consumed in the afterburner 117.

Referring again to FIG. 1A, the fuel cell stack array 108 is coupled to a Heat Recovery Unit (HRU) 118. During operation, the fuel cell stack array 108 generates heat in addition to electrical power. The heat can be captured by the HRU 118, which is operable to generate electrical power from the heat. The HRU 118 can thereby take some of the load off the fuel cell stack array 108, prolonging the lifespan of the fuel cells 109. Various configurations of HRU 118 can be used, and by way of non-limiting example, some configurations include: a thermoelectric HRU, a microturbine HRU, a Rankine cycle HRU, and a Stirling engine HRU.

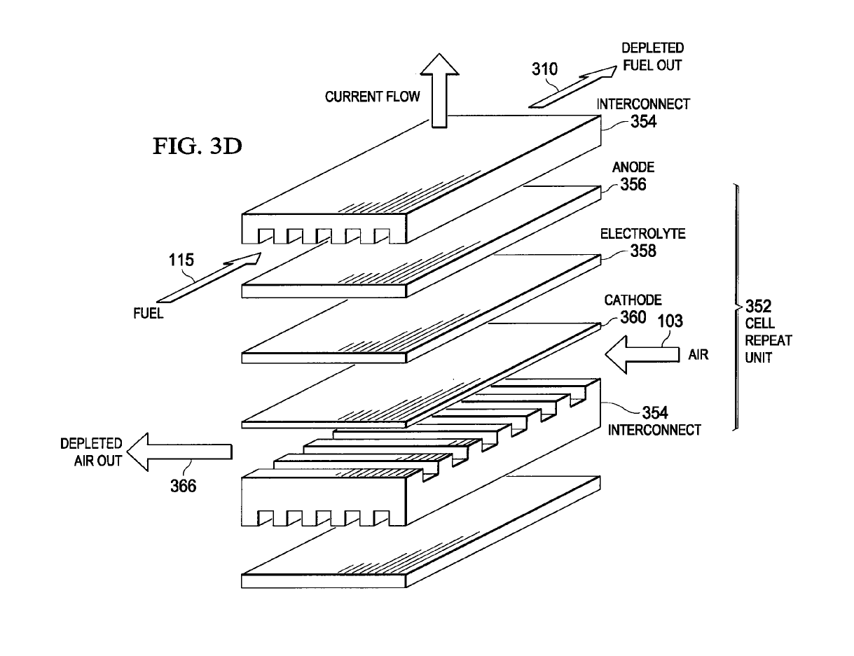

Referring to FIG. 4, a schematic representation of an example implementation of an HRU 400 (e.g., HRU 118) is shown for illustrative purposes. In some implementations, the HRU 400 can employ a mechanical/thermodynamic process based upon the Rankine Cycle that takes excess heat and converts it to electricity. The process starts with a pump 402 or compressor that compresses a liquid to a high pressure and drives the pressurized liquid to a heat exchanger 404 operating as a vapour generator. The heat exchanger 404 can be designed to capture the available excess heat from the fuel cell stack array 108 and the afterburning of the depleted fuel/depleted air exiting the fuel cell stack array 108 via the liquid. Within the heat exchanger 404, the liquid experiences a phase change from a liquid to a superheated vapour. The superheated vapour enters a heat engine 406 where it expands, significantly reducing its pressure. The heat engine is attached to a generator or alternator where the heat engine work is converted to electricity. The low pressure vapour leaving the heat engine enters a condenser 412, where the remainder of the waste heat is rejected to a cold sink (e.g., atmosphere or liquid coolant) and the vapour experiences another phase change from vapour to liquid. From here the liquid returns to the pump/compressor 402 to complete the cycle.

In other implementations, the HRU 400 can employ a mechanical/thermodynamic process based upon the Stirling Cycle that takes excess heat and converts it to electricity. The process employs a working gas without a pump or compressor. The heat exchanger 404 can be configured to capture the available excess heat from the fuel cell stack array 108 and the afterburning of the depleted fuel/depleted air exiting the fuel cell stack array 108 and transfer this heat to the working gas. The gas expands from the hot zone into a cooling zone while moving a piston during the displacement. The Stirling engine is attached to a generator or alternator where the engine work is converted to electricity. The heat exchanger 412 can be configured to cool the gas, which then returns to the heating zone to continue the cycle. Heat exchanger 412 can be configured to reject the remainder of the waste heat to a cold sink (e.g., atmosphere or liquid coolant).

In other implementations, the HRU 400 can employ a thermoelectric principle that takes excess heat and converts it directly to electricity with no moving parts or intermediate heat transfer media. The heat exchanger 404 can be configured to capture the available excess heat from the fuel cell stack array 108 and the afterburning of the depleted fuel/depleted air exiting the fuel cell stack array 108 and transfer this heat directly to the thermoelectric material. Heat exchanger 412 can be configured to draw the heat through the thermoelectric material and reject the remainder of the waste heat to a cold sink (e.g., atmosphere or liquid coolant). The heat flow through the thermoelectric material generates the electricity.

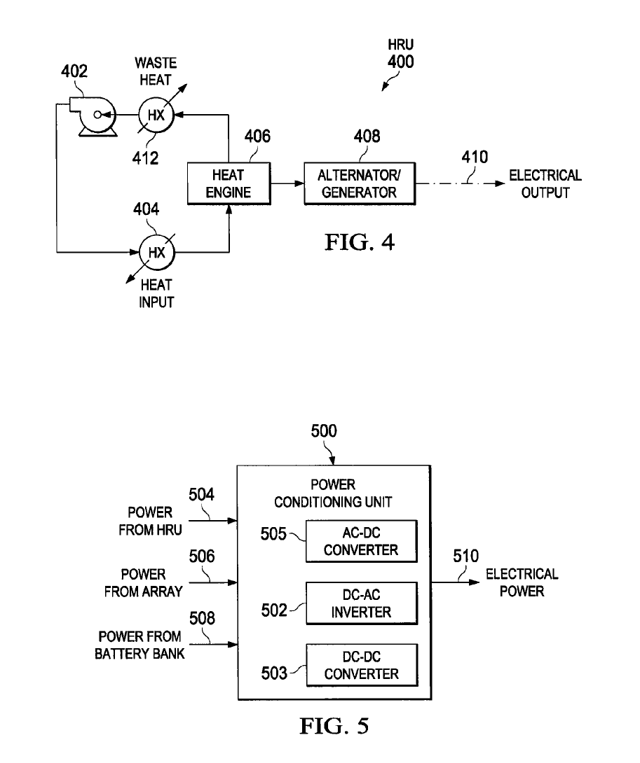

Referring again to FIG. 1A, the fuel cell stack array 108 can generate a DC current. In the implementation shown, the fuel cell stack array 108 and HRU 118 are coupled to a power conditioning unit (PCU) 116. The PCU 116 is operable to condition the output from the fuel cell stack array 108 and HRU 118 in accordance with desired output requirements for the power generation system 100. For example, if the power generation system 100 is required to produce an AC current, the PCU 116 can include an inverter to change the DC output from the fuel cell stack array 108 into an AC current. In another example, the PCU 116 can be used to condition the voltage of the output, according to the load on the system 100. Referring to FIG. 5, a schematic representation of an example implementation of a Power Conditioning Unit PCU 500 (e.g., PCU 116) is shown for illustrative purposes. The PCU 500 can include a DC-AC inverter 502, a DC-DC converter 503 and/or, an AC-DC converter 505. Input to the PCU 500 can include power 504 from the HRU 118, power 506 from the array of fuel cell stacks 108 and power 508 from a battery bank. A control unit 120 (FIG. 1A) controls the flows and pressures of fuel, air and thus temperatures within the entire system 100. Power generated from the battery bank 508, the array of fuel cell stacks 108, and the HRU 118 is monitored and passed to the PCU 500, which converts this to a usable type and state for the customer load and internal power requirements. The PCU 500, may contain any or all of the following sub components, a DC-AC Inverter 502, a DC-DC converter 503 and/or an AC-DC converter 505.

Referring again to FIG. 1A, the system 100 can include the control unit 120 operable to control one or more operating parameters of the system 100. Certain variables can be monitored within the system 100, and based on the values of one or more variables, the control unit 120 can adjust the operating parameters to achieve a desired output. For example, the temperature, pressure, voltage and current at one or more locations within the system 100 can be monitored. Operating parameters, including for example, the flow rate of the air and/or fuel into the system 100 can be adjusted.

In some implementations, the power generation system 100 is used to provide a substantially constant power output, e.g., as contrasted to a system that provides a substantially constant voltage output with a decreasing power output over time. Referring to FIG. 1B, a simplified graph is shown to depict the relationship between the voltage and current of a fuel cell stack 107 included in the fuel cell stack array 108. The curve 150 represents the relationship at time T₁, which is before the fuel cells 109 included in the fuel cell stack array 108 have degraded. The area under the curve represents the electrical power output of the fuel cell stack 107 when generating a particular current. For example, at time T₁ when the current generated by the fuel cell stack 107 is I₁, then the power output is P₁ represented by the area 152, where P₁ is the product of V₁ and I₁. The area represented by 153 is the heat produced at the beginning of life condition.

However, over time as the one or more fuel cells 109 included in the stack 107 degrade, the curve 150 shifts. An example shifted curve 154 at time T₂ is shown as a broken line, to represent the relationship between the voltage and current at a later time during the lifecycle of the fuel cells 109. Referring to FIG. 1C, the later time T₂, when the fuel cells 109 have degraded, the power output P₂ (as is illustrated by the area 155) is less for the same current I₁. That is the area P₂<the area P₁. To maintain a constant power output, the control unit 120 can be operable to adjust the flow rate of fuel 104 and/or air 102 input into the system to increase the current generated by the fuel cell stack array 108. The fuel cells 109 continue to degrade over time until such time as the operational voltage produced by the fuel cell stack array 108 no longer meets the requirements of the PCU, which can necessitate a stack changeout.

The increased current can compensate for the degradation of the fuel cells 109 to maintain a substantially constant power output, as illustrated by FIG. 1D. In FIG. 1D, at the later time T₂, the current is increased to I₂. The power generated by the fuel cell stack 107 when the current is I₂ is represented by P₂′, the area under the curve 154. The area P₂′ is equal to the area P₁, and thus a constant power output has been maintained, in spite of the degrading fuel cells 109. There comes a point in time where the fuel cell stack 107 is changed out because the generating voltage is too low for the PCU 116 to function properly.

Referring again to FIG. 1B, the area above the curve 150 formed by a horizontal line extending from the initial operating voltage V₀, that is, area H₁ 153, represents the heat generated by the fuel cell stack array 108. Referring to FIG. 1D, the increase in heat generated over time as the current is increased is illustrated. That is, the heat H₂ 156 generated at time T₂ is substantially greater than the heat H₁ generated at time T₁. This heat generated by the fuel cell stack array 108 can be recovered by the HRU 118, as discussed above, and used to generate electrical power. The more electrical power generated by the HRU 118, the less power required to be generated by the fuel cell stack array 108 to maintain a substantially constant power output, thereby prolonging the life of the fuel cells 109 included in the array 108.

In some implementations, the control unit 120 is operable to monitor a voltage output from the fuel cell stack array 108 and to control the feed of hydrogen rich gas 115 and/or pre-heated air 103 to the array 108 based on the monitored current and voltage. The estimated relationship between the voltage and current based on an estimated degradation of the fuel cell stack at a given time, i.e., the shifted curve 154 for the given time, can be used together with the monitored voltage by the control unit 120 to determine a modified level of current output required to meet the power output requirements. The control unit 120 can then determine how to adjust the flow rates of fuel and/or air input into the fuel processing unit 114 the array 108 to generate the modified level of current output. Curves 150 and 154 are graphical representations of the stack performance of a particular type of supplier stack. The PCU 116 monitors airflow via airflow sensors, the pressures via pressure sensors and temperatures via thermocouples. By monitoring these sensors which are placed throughout the system, the PCU can use a complex Proportional-Integral-Derivative (PID) control process to limit the fuel/temperature, such that the voltage output from curves 150 and 154 are optimized. In some implementations, the monitoring and optimization described above is done by the control unit 120 or another component within the system.

In other implementations, the current from the fuel cell stack array 108 can be monitored either alone or together with the voltage, and the monitored value (or values) used together with the estimated relationship between the voltage and the current used to determine the air and fuel flow rates necessary to meet the required power output.

In some implementations, the control unit 120 can be operable to monitor the power output generated by the HRU 118 and to adjust the fuel and/or air flow rates into the fuel cell stack array 108 to increase or decrease the current output by the array 108 accordingly, to maintain the desired constant power output. That is, the load on the fuel cell stack array 108 can be minimized, thereby prolonging the lifespan of the fuel cells 109.

In some implementations, the reformer reactor 113 is a CPOx reactor and each fuel cell stack 107 includes at least one SOFC. In such implementations, the control unit 120 is operable to control the feed rates of hydrogen rich gas and/or oxygen to the fuel cell stack array 108 to maintain a substantially constant output of power for at least 18 months. Such a life span is relatively long for a fuel cell stack including one or more SOFCs. However, because the HRU 118 takes some of the load off the fuel cell stack array 108 to generate the desired power output, the longevity of the fuel cell stack array 108 is enhanced. The control unit 120 can be further operable to monitor the power generated by the HRU 118 and to adjust the feed rates of hydrogen rich gas 115, fuel to the entire system 104, and/or pre-heated air 103 and/or the air to the reformer 105 to the fuel cell stack array 108 accordingly, depending on how much additional power must be generated by the fuel cell stack array 108 to maintain the desired power output.

In other implementations, the control unit 120 is operable to control the feed rates of hydrogen rich gas and/or oxygen to each fuel cell stack 107 in the array 108 on a stack-by-stack basis. In such implementations, the control unit 120 can monitor variables of each stack 107 on a stack-by-stack basis, and accordingly adjust operating parameters for each stack 107 based on the corresponding information obtained from monitoring the particular stack 107.

In the example implementation described, the fuel 104 is natural gas or methane. However, other fuels can be used, including without limitation, propane, diesel or gasoline. Using empirical data obtained from experimental tests, the air to fuel ratio at which coking will occur can be determined. With this information, the PID loop monitors the output and determines if a coking state starts to occur, the PID control loop can automatically attempt to adjust the fuel and air flow rates until the issue is resolved.

In some implementations, the power generation system 100 can include a battery bank 160. This battery bank can be used primarily for startup conditions, where the system has not achieved the steady state full power capability. It can also be used as a supplementary system to condition power spikes and dips in load-following situations. Additionally, the load on the power generation system 100 may vary during the course of a day. Accordingly, if the power output is substantially constant, the battery bank 160 can be used to soak up the spikes in demand. The battery bank 160 can be charged by the output from the PCU 116 and provide a reliable flow of electricity when needed.

In some implementations, the system 100 can optionally include a self-diagnostic unit 170. The self-diagnostic unit can be operable to diagnose a failure and provide information about possible fixes. When powering up the system 100, the self-diagnostic unit 170 can go through a check to confirm the unit has connections to all system sensors and that the initial values for sensors fall within predefined ranges. If a sensor, value or other component does not report an appropriate value, an error code can be provided to a HMI (human machine interface) unit and in some circumstances, the system can become locked out. Optionally, the system 100 can include a network connection 180, either wired or wireless, to permit operating parameters of the system 100 to be monitored and/or adjusted remotely. For example, the network connection can be a VPN (virtual private network) connection. In some implementations, the system can include an Ethernet connection and can support its own encrypted web page for monitoring purposes. In some implementations, GSM, CDMA and UMTS options can be available, e.g., for long range wireless monitoring.

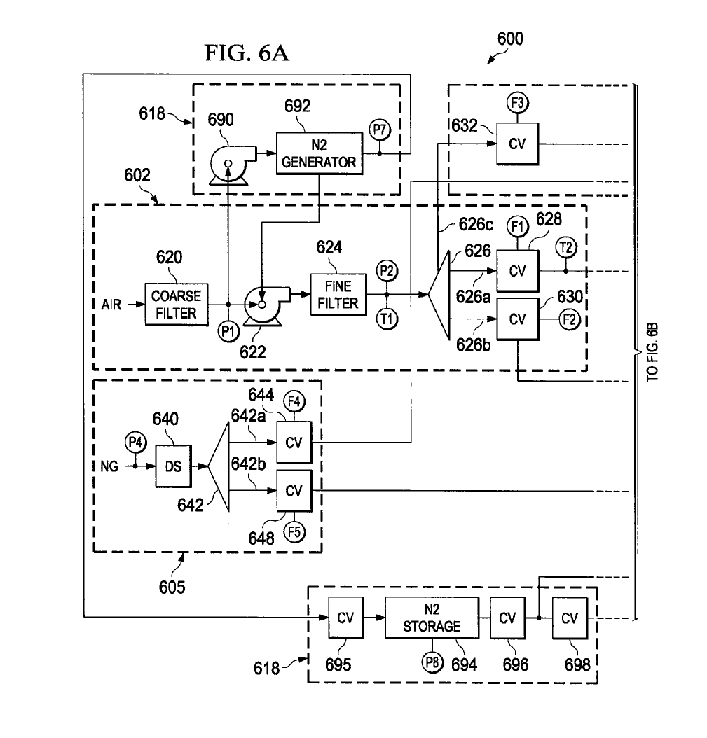

FIG. 6 illustrates a specific embodiment of a power generation system 600. In this embodiment, the power generation system 600 is a water-independent system in that water is not used as a feed to the power generation system 600. The generation system 600 may in this embodiment use air as a source of oxygen, natural gas as a source of fuel, a CPOx reformer and SOFC's. Other suitable types of fuel and oxygen sources may be used. In addition, other types of reformers may be used.

Referring to FIG. 6, the power generation system 600 may comprise an air delivery system 602, an air preheat system 604, a fuel delivery system 605, a fuel processing system 606, a fuel cell system 608, a burner system 610, an exhaust gas system 612, a heat recovery unit (HRU) system 614, a power conditioning unit (PCU) system 616, and a purge system 618. The air preheat system 604, the fuel processing system 606, the fuel cell system 608, the burner system 610 and portions of the HRU system 614 may be disposed in a hot box 615. Various illustrated systems and elements of the power generation system 600 may be modified, supplemented, and/or omitted without departing from the scope of the present disclosure. For example, the fuel delivery system 605 and the fuel processing system 606 may be replaced with syngas delivery system. As another example, the exhaust gas system 612 may be omitted. In addition, other elements of the power generation system 600 may be included in or omitted from the hot box 615. Further still, for example, the power generation system 600 may include several hot boxes operating independently or in connection with one another in place of a single centralized hot box 615.

The air delivery system 602 may comprise a first filter 620, a blower 622, a second filter 624 and a manifold 626. The first filter 620, pump 622, second filter 624 and manifold 626 may be connected or otherwise coupled together in series. In one embodiment, the first filter 620 may comprise a coarse filter for filtering ambient air prior to blower 622. In this embodiment, the second filter 624 may comprise a fine filter for further filtering air output by the blower 622. A pressure sensor P1 may be located at the outlet of the coarse filter to sense air pressure at that point. A pressure sensor P2 may be located at the outlet of the fine filter 624 to sense air pressure at that point. A temperature sensor T1 may also be located at the outlet of the fine filter 624 to sense temperature at that point. Air pressure sensors P1 and P2 may be used to determine if the first or second air filter 620 or 624 need replacement and if the blower 622 is operating properly. Air temperature sensor T1 may be used in connection with downstream temperature sensor to control and/or determine the operational condition of the power generation system 600 and/or components of the system.

In one embodiment, the air manifold 626 includes an air feed 626a to the air preheat system 604, an air feed 626b to the fuel processing system 606 and an air feed 626c to the burner system 610. Air feed 626a may be connected to air preheat system 604 via control valve 628. Control valve 628 controls cathode air to the fuel cell system 608. Air feed 626b may be connected to fuel processing system 606 via control valve 630. Control valve 630 controls CPOx air to the fuel processing system 606. Air feed 626c may be connected to burner system 610 via control valve 632. The air feeds and associated valves may be connected or otherwise coupled together in parallel in this embodiment.

Control valve 628 may include flow sensor F1 to sense and regulate flow of air through the valve. Control valve 630 may include flow sensor F2 to sense and regulate flow of air through the valve. Control valve 632 may include flow sensor F3 to sense and regulate flow of air through the valve. In addition, a temperature sensor T2 may located at the outlet of control valve 628 to sense the temperature of the air entering the air preheat system 604. The sensors may also be used alone, together and/or with other sensors to control and/or determine the operational condition of the power generation system 600.

The air preheat system 604 may comprise a first heat exchanger 634 and a second heat exchanger 636. The first heat exchanger 634 may be connected to and receive air via the cathode air control valve 628. In one embodiment, the first heat exchanger 634 may be a primary heat exchanger and the second heat exchanger 636 a secondary heat exchanger. In this embodiment, the first and second heat exchangers 634 and 636 may be connected or otherwise couple together in series with the first, or primary, heat exchanger 634 heating air to an intermediate temperature and the second, or secondary, heat exchanger 636 heating the air from the intermediate temperature to a temperature below that of the fuel cell system 608 operating temperature. The first and second heat exchangers 634 and 636 may each comprise a series of coils, shell and tubes, plate and fins and/or other suitable components and configurations operable to use heat generated by the power generation system 600 to heat air for the fuel cell system 608. A temperature sensor T3 may be located at the outlet of the first heat exchanger 634 to sense the temperature of the air at that point and/or after primary heating. A temperature sensor T4 may be located at the outlet of the second heat exchanger 636 to sense the temperature of the air at that point, after secondary heating and/or entering the fuel cell system 608. A pressure sensor P3 may also be located at the outlet at the second heat exchanger 636 to sense the pressure of the air at that point, after preheating and/or entering the fuel cell system 608. The sensors may also be used alone, together and/or with other sensors to assist in the control and/or determine the operational condition of the power generation system 600.

The fuel delivery system 605 may comprise a desulphurizer 640 and a fuel manifold 642. The desulphurizer 640 and the fuel manifold 642 may be connected or otherwise coupled in series. The desulphurizer 640 removes sulphur compounds from the fuel at the inlet of the power generation system 600. The fuel may comprise natural gas, methane, propane or other hydrocarbon fuel from a pipeline or other suitable source. The fuel may be in a gaseous or other suitable form, such as, for example, another type of fluid.

A pressure sensor P4 may be located at the inlet of the desulphurizer 640 to sense the pressure and/or the fuel gas flowrate entering the power generation system 600. Although not illustrated, the fuel delivery system 605 may include a pressure control valve or system to step down or up the pressure of fuel gas entering the desulphurizer 640. For example, if natural gas from a pipeline is used, the gas pressure must be stepped down from pipeline pressure to a lower pressure before entering the power generation system 600.

The fuel manifold 642 includes a first fuel feed 642a to the burner system 610 and a second fuel feed 642b to the fuel processing system 606. Fuel feed 642a may be connected to the burner system 610 via control valve 644. Fuel feed 642b may be connected to the fuel processing system 606 via control valve 648. Control valve 648 controls the fuel feeding the fuel processing system 606. The fuel feeds and associated valves may be connected or otherwise coupled together in parallel in this embodiment.

Control valve 644 may include flow sensor F4 to sense the flow of fuel through the valve. Control valve 648 may include flow sensor F5 to sense the flow of fuel through the valve. The sensors may also be used alone, together and/or with other sensors to assist in the control and/or determine the operational condition of the power generation system 600.

The fuel processing system 606 may comprise a CPOx reformer 650. Other suitable reformers may be used in the water-independent embodiment of the power generation system 600. The CPOx reformer 650 receives air via the CPOx air control valve 630 and fuel via the fuel control valve 648. As previously described, the CPOx reformer 650 generates a hydrogen-rich fuel for the fuel cell system 608 using air and fuel provided by the air and fuel delivery systems 602 and 605.

A pressure and/or flow sensor P5 may be located at the outlet of the CPOx reformer 650 to sense pressure and/or the hydrogen-rich fuel flowrate at that point and/or entering the fuel cell system 608. A temperature sensor T5 may also be located at the outlet of the CPOx reformer 650 to sense temperature of the hydrogen-rich fuel at that point and/or entering the fuel cell system 608. The sensors may also be used alone, together and/or with other sensors to assist in the control and/or determine the operational condition of the power generation system 600.

Fuel cell system 608 may comprise fuel cell array 655 connected to or otherwise coupled to the second heat exchanger 634 to receive preheated air and to the CPOx reformer 650 to receive hydrogen rich fuel gas. Fuel cell array 655 may include one or more fuel cell stacks 656. In specific embodiments, for example, fuel cell stacks 656 may comprise 2, 4, 6 or 8 fuel cell stacks 656. Other suitable numbers of fuel cell stacks may be used. The fuel cell stacks 656 may be arranged in a circular, oval, race track or other suitable configuration in the hot box 615. Each fuel cell stack 656 may comprise one or more fuel cells. As previously described, each fuel cell may utilize oxygen from the preheated air and the hydrogen-rich fuel to generate electricity. In a particular embodiment, each fuel cell is a SOFC as described in connection with FIGS. 3A and B. In other embodiments, the fuel cells may comprise SOFCs as described in connection with FIGS. 3C and 3D.

A current sensor I1 may be located at the fuel cell stacks 656 to sense and regulate current at that point and/or generated by the fuel cell stacks 656. A voltage sensor V1 may be located at the fuel cell stacks 656 to sense and regulate voltage at that point and/or generated by the fuel cell stacks 656. The sensors may also be used alone, together and/or with other sensors to control and/or determine the operational condition of the power generation system 600. The power generated by the fuel cell stacks 656 is provided to the PCU 616 via one or more electrical contacts.

In the illustrated embodiment, exhaust 658 from fuel cell stacks 656 is released into the hot box 615. The exhaust 658 includes anode exhaust and cathode exhaust. However, it should be understood, as is discussed further below, in some implementations, as shown, a portion of the anode exhaust can be recycled, and is directed to an ejector 659 before being directed into the CPOx 650. Any unconsumed fuel exhausted by the fuel cell stacks 656 may be burned at the perimeter of each fuel cell stack 656 or by the burner system 610. The burner system 610 may comprise an afterburner/pilot 660. The after burner/pilot 660 receives air via control valve 632 and fuel via control valve 644. In addition to burning unconsumed fuel, the afterburner/pilot 660 may be used to preheat the hot box 615 during start-up of the power generation system 600. Other suitable types of afterburners, pilots, and/or heater may be used for the burner system 610 without departing from the scope of the present invention. Exhaust 662 from the afterburner/pilot 660 may also be released into the hot box 615.

Exhaust 658 from the fuel cell stack 656 and exhaust 662 from the afterburner/pilot 660 may exit the hot box 615 via a chimney 664 and flow through the exhaust system 612. The exhaust system 612 may include a heat exchanger 665, a scrubber 666 and a blower 668. The heat exchanger 665, scrubber 666 and blower 668 may be converted or otherwise coupled in series. The heat exchanger 665 removes heat from the exhaust prior to scrubbing by the scrubber 666. In one embodiment, the heat exchanger 665 may reduce the temperature of the exhaust gas to about 120° C. The heat exchanger 665 may comprise a set of coils, shell and tubes, plate and fins and/or other suitable components and configurations operable to remove heat from exhaust of the power generation system 600. Scrubber 666 may remove CO₂ and/or other components from the hot box 615 exhaust gas prior to release in the atmosphere. Blower 668 creates a vacuum to draw exhaust gas through the scrubber 666 and releases exhaust gas to the atmosphere.

A temperature sensor T7 may be located at the input of the heat exchanger 665 to sense temperature entering the heat exchanger and/or exiting the hot box 615. The sensor may also be used alone, together and/or with other sensors to assist in the control and/or determine the operational condition of the power generation system 600.

The HRU system 614 may comprise a first heat exchanger 670, a second heat exchanger 671, a HRU 672, a third heat exchanger 674, and a pump 675. The first heat exchanger 670, the second heat exchanger 671, the HRU 672, the third heat exchanger 674, and the pump 675 may be connected or otherwise coupled in a loop. The first heat exchanger 670 removes heat from the hot box 615. The second heat exchanger 671 removes heat from the afterburner/pilot 660. The collected heat is provided to the HRU 672. As described above, the HRU 672 converts the heat into electrical power. Excess heat remaining after the HRU 672 is released to the atmosphere by the third heat exchanger 674. In other embodiments, the remaining excess heat may be otherwise used within the power generation system 600. The first, second and third heat exchangers 670, 671 and 674 may each comprise a set of coils, shell and tubes, plate and fins and/or other suitable components and configurations.

In the HRU system 614, the pump 675 circulates a fluid through the first heat exchanger 670, the second heat exchanger 671, the HRU 672 and the third heat exchanger 674. A temperature sensor T8 may be located at the outlet of the second heat exchanger 671 to sense temperature at that point and/or at the inlet of the HRU 672. A temperature sensor T9 may be located at the outlet of the third heat exchanger 674 to sense temperature at that point and/or of the fluid returning to the hot box 615.

A current sensor 12 may be located at the HRU 672 to sense current at that point and/or generated by the HRU 672. A voltage sensor V2 may also be located at the HRU 672 to sense voltage at that point and/or generated by the HRU 672. The sensors may also be used alone, together and/or with other sensors to assist in the control and/or determine the operational condition of the power generation system 600. The power generated by the HRU 672 is provided to the PCU 616 via one or more electrical contacts.

In the illustrated embodiment, the hot box 615 includes the first and second heat exchangers 634 and 636 of the air preheat system 604, the CPOx reformer 650, the fuel cell stacks 656, and the first heat exchanger 670 and the second heat exchanger 671 of the HRU system 614. The hot box may include other, additional or fewer components in other embodiments. The hot box 615 may, as described in more detail below, operate at a temperature of about 800 degree C. to 850 degree C. and at a pressure slightly below atmospheric. The hot box 615 may in other embodiments operate at other suitable temperatures and pressures. The hot box 615 may be sized and shaped to optimize or enhance the temperature thermal integration in the hot box 615 as well as other operational characteristics.

The hot box 615 may include a temperature sensor T10 to sense the temperature of the hot box 615. A pressure sensor P6 may also be included to sense pressure of the hot box 615. The sensors may also be used alone, together and/or with other sensors to assist in the control and/or determine the operational condition of the power generation system 600.

The PCU system 616 comprises PCU 680. The PCU 680 receives power from the fuel cell stacks 656 and the HRU 672. As described above, the PCU 680 conditions power for use by the power generation system 600 and for provision to a load.

A current sensor 13 may be located at the PCU 680 to sense current at that point and/or produced by the PCU 680 or the power generation system. A voltage sensor V3 may also be located at the PCU 680 to sense voltage at that point and/or generated by the PCU 680. The sensors may also be used alone, together and/or with other sensors to assist in the control and/or determine the operational condition of the power generation system 600.

The purge system 618 may comprise a pump or compressor 690, a nitrogen generator 692 and a nitrogen storage tank 694. The pump 690, nitrogen generator 692 and nitrogen storage tank 694 may be connected or otherwise coupled in series. The compressor 690 receives filtered air from the air delivery system 602 and provides air to the nitrogen generator 692. The nitrogen generator 692 outputs nitrogen gas to a nitrogen storage tank 694 via a control valve 695. In one embodiment, oxygen rich air extracted by the process in the nitrogen generator 692 is returned to the blower 622 of the air delivery system 602 to raise the oxygen level above that of ambient air. The oxygen exhausted from the nitrogen generator 692 may be otherwise used in or exhausted from the power generation system 600.

Nitrogen from the nitrogen tank 688 may be provided to the CPOx reformer 650 and/or the fuel cell stacks 656 for purging during system shut down. In the illustrated embodiment, nitrogen is provided to the CPOx reformer 650 via control valve 696 and to the fuel cell stacks 656 via control valve 698.

A pressure sensor P7 may be located at the output of the nitrogen generator 692 to sense pressure at that point and/or generated by the nitrogen generator 692. A pressure sensor P8 may be located at the nitrogen storage tank 694 to sense the tank pressure and/or to assist in the startup and shutdown of the nitrogen generator 692. Thus, when the tank 694 is full, the control system 120 of FIG. 1A may shut down the compressor 690 and the nitrogen generator 692.

Each of the control valves of the system 600 may be a metering valve operable to precisely meter a gas or liquid or other suitable fluid. In this embodiment, the metering valves may be fully controllable between 0 and 100% open and closed. In another embodiment, one or more of the control valves may be two position valves with only an open position and a close position. For example, in a particular embodiment all the control valves may be metering valves except for control valves 695, 696 and 698 which may be two-way failopen control valves.

The pressure, temperature, flow, current and voltage sensors may be wired to a control system for the power generation system 600 or equipped to otherwise suitably communicate with the control system. For example, one or more of the sensors may be wireless sensors that communicate wirelessly with the control system of power generation system 600. The wireless or wired sensors may communicate directly with the control system or may communicate with the control system over network such as a local area network in the power generation system 600. Other, additional or fewer sensors may be used or otherwise arranged in the power generation system 600. The sensors can be industrial, high temperature sensors.

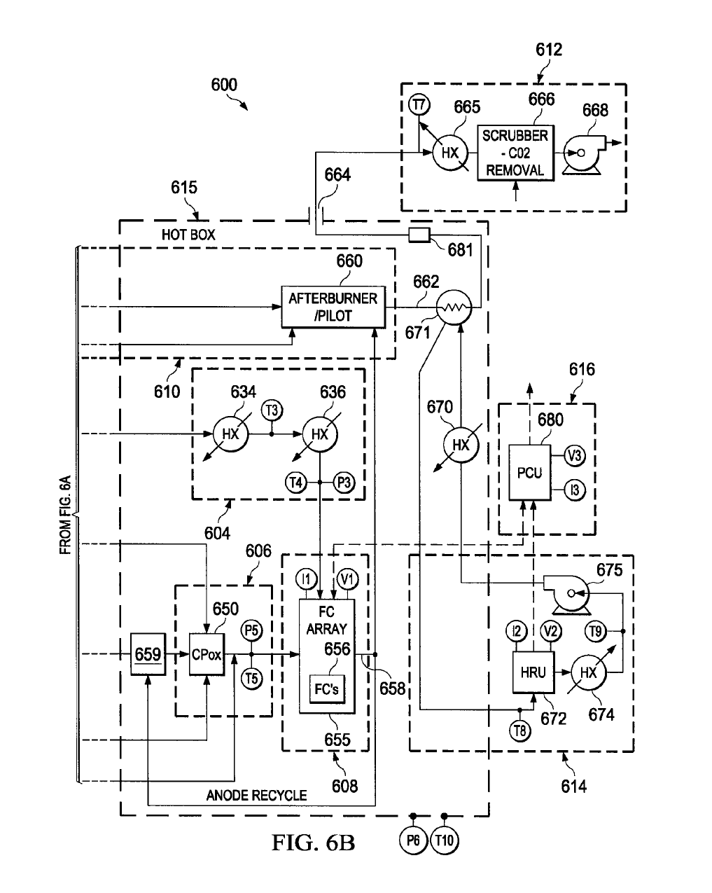

FIGS. 7A-C illustrate different views of the power generation system 600 as configured in a portable power generation unit 700. Unit 700 is portable in that it is built on a skid, in a container or otherwise that can be moved as a unit by fork lift, small crane or otherwise. In particular, FIG. 7A illustrates a perspective view of the power generation unit 700. FIG. 7B illustrates a schematic interior view of the power generation unit 700. FIG. 7C illustrates a schematic top view of the hot box 615 (FIG. 6) of the power generation unit 700. It will be understood that the power generation system 700 may be otherwise configured and the elements otherwise arranged in a portable or other unit.

Referring to FIG. 7k the power generation unit 700 may also be self-contained, integrated and/or and transportable and/or mobile as a single unit. In the illustrated embodiment, the power generation unit 700 may have a width 702, a depth 704 and a height 706. In a particular embodiment, the width may be approximately 3.5 feet, the depth approximately 5.5 feet and the height approximately 3.5 feet. An exhaust port 710 may extend from the top of the power generation unit 700. In this embodiment, the power generation unit 700 may have a small footprint and may be easily ported to remote areas and into high density urban areas for installation and use. For example, the power generation unit 700 may in one embodiment weighs approximately 270 kilograms. The size, weight, and dimensions of the power generation unit 700 may be suitably varied without departing from the scope of the present disclosure.

Referring to FIG. 7B, the power generation unit 700 may include the hot box 615 and a cold zone 715. In one embodiment, the hot box 615 may operate at temperatures of about or at 800° to 850° C. while the cold zone remains about or at or below 40° C. In this embodiment, the hot box 615 may be separated from the cold zone 715 by an insulated wall 720.

The hot box 615 may, as previously described, include the CPOx reformer 650, fuel cells stacks 656 and the first and second heat exchangers 634 and 636. Although not illustrated, the afterburner/pilot 660 and the first heat exchanger 670 and the second heat exchanger 671 of the HRU system 614 may also be disposed in the hot box 615. For example, the afterburner/pilot 660 may be disposed above the fuel cell stacks 656 to burn any unconsumed part of the gas 658 exhausted by the fuel cell stacks 656. The first heat exchanger 670 of the HRU system 614 may, for example, be disposed about the first heat exchanger 634. The elements of the power generation unit 700 in the hot box 715 may be otherwise suitable configured and arranged.

In the illustrated embodiment, the fuel cell array 655 comprises eight SOFC stacks 656 arranged in a circle or otherwise substantially equidistant from each other and/or the CPOx reformer 650. The first heat exchanger 634 may be connected or otherwise suitable coupled to the air delivery system 602 and comprise a set of coils wrapped around or outwardly of the CPOx reformer 650. The second heat exchanger 636 may be connected or otherwise suitably coupled to the first heat exchanger 634 and comprise a set of coils wrapped around or outwardly of the fuel cell array 655. Preheated air from the second heat exchanger 636 may flow to a fuel cell air manifold 725 for distribution to the SOFC's 656. The first and second heat exchangers 634 and 636 may be otherwise configured. For example, in another particular embodiment, the second heat exchanger 636 may comprise a distributed series of coils each separately wrapped around or outwardly of a disparate fuel cell stack 656. In this embodiment, the air from the first heat exchanger 634 may be separately provided to each set of coils and, after heating, remixed in the air manifold 725.

In some implementations, three or more air heat exchangers can be included in the system of various types and at various positions, for example, around the reformer reactor, the fuel cell stacks and/or the afterburner. The order of primary, secondary and tertiary air heat exchangers can be determined differently in different implementations. That is, as discussed above, in some implementations the first heat exchanger 634 is the primary heat exchanger. However, in other implementations, a different heat exchanger can be the primary heat exchanger, and the first heat exchanger 634 can be the secondary, tertiary or otherwise heat exchanger. Other configurations are possible.

Fuel enters the hot box 615 via the fuel delivery system 605 and is fed to the CPOx reformer 650 along with air from the air delivery system 602. At the CPOx reformer, the fuel is converted into a hydrogen-rich fuel which is provided to a fuel manifold 730 for distribution to each fuel cell stack 656. Oxygen and fuel may be otherwise suitably distributed or provided to the fuel cell array 655 and/or SOFC's 656.

Exhaust gases 658 from the SOFC's 656 may be released into the hot box 615 and may exit the hot box 615 via port 664 (FIG. 6). The exhaust gas system 612 (FIG. 6) may be located above the hot box 615, in the cold zone 715, in the exhaust port 710 (FIG. 7A), or otherwise suitably.

The cold zone 715 may be divided into a plurality of sections. For example, in the illustrated embodiment, the HRU 672 of the HRU system 614 (hot box 615) and the PCU 680 of the PCU system 616 may be disposed in a first section 750 of the cold zone 715 while a control system 755 is disposed in a second section 752 and the air and fuel delivery systems 602 and 605 are disposed in a third section 754. Although not shown, the PCU 680 includes one or more external or internal electric ports for connecting and powering a load.

The control system 755 may comprise a network sub-system 755a, self-diagnostic sub-system 755b and a control sub-system 755c. Control system 755 may be implemented by one or more computers or processors or processing devices including suitable media storing instructions for complete operation of the power generation unit 700. The control system 755 may, for example, comprise persistent or nonpersistent memory encoded with software code for operating the unit 700.

The network sub-system 755a may comprise an internal network for communicating with sensors and other elements in the power generation unit 700 and a transceiver and/or other devices for communicating within a wide area network such as a telephone network, cell telephone network, a wireless network, satellite network, the Internet, a broadband network or other suitable network. The network sub-system 755a may allow the power generation unit 700 to be wholly or partially operated remotely over a network link or connection, be partially programmed remotely and/or be monitored remotely. The network sub-system 755a may also upload information on operation of the power generation unit 700 to a remote control or monitoring station and/or download software or firmware updates.

The self-diagnostic sub-system 755b may perform diagnostics on the power generation unit 700 during start-up, pre-run, run, and/or shut down modes. The self-diagnostic sub-system 755b may notify the control sub-system 755c of any problems within the power generation unit 700 and may upload error and other diagnostic messages to a remote station using the network sub-system 755a.

The control sub-system 755c may control operation of the power generation unit 700, including start-up, pre-run, run and/or shut down modes. For example, the control sub-system 755c may take action in the power generation unit 700 in response to or based on data and information from sensors and/or from the self-diagnostic sub-system 755b, the network sub-system 755a or other unit, device or system. Thus, the control sub-system may process messages and information based on the content or structure of the information and take or not take one or more actions based on the content, structure or timing of the information. The message or information may be any data sent from or to any sensor or device in or outside the unit 700. The control sub-system 775c may shut down the unit 700 in response to a problem indicated by self-diagnostic sub-system 755b. The control sub-system 755c may control the air and fuel delivery systems 602 and 605 to control power generated by the power generation unit 700 and to control the voltage and current of the power generated by the unit 700.

Referring to FIG. 7C, the hot box 615 includes in the illustrated embodiment the CPOx reformer 650 disposed substantially at the center of the hot box 615. In this embodiment, the SOFC's or other type of fuel cell stacks 656 are disposed around, but vertically above the CPOx reformer 650 as illustrated in FIG. 7B or otherwise vertically displaced from the CPOx reformer 650. In operation, the CPOx reformer 650 and the SOFC's 656 each operate at a temperature of approximately of 800° to 850° C. Air in the first heat exchanger 634 may be heated to an intermediate temperature of about 400° C. and then pass to a second heat exchanger 636 where it is heated to approximately 750° to 800° C. before entering the fuel cell stacks 656. Thus, the intermediate and final temperatures for a CPOx/SOFC embodiment may vary by 10° C., 20° C. or, 50° C. Other embodiments may operate at other suitable temperatures. It will be understood that the SOFC or other fuel cell stacks 656 may be otherwise disposed relative to each other and to the CPOx reformer 650. In addition, the first and second heat exchangers 634 and 636 may be otherwise configured or disposed within the hot box 615 or relative to the fuel cell stacks 656 or the CPOx reformer 650. The hot box 615 may be maintained a temperature of about 800° C.

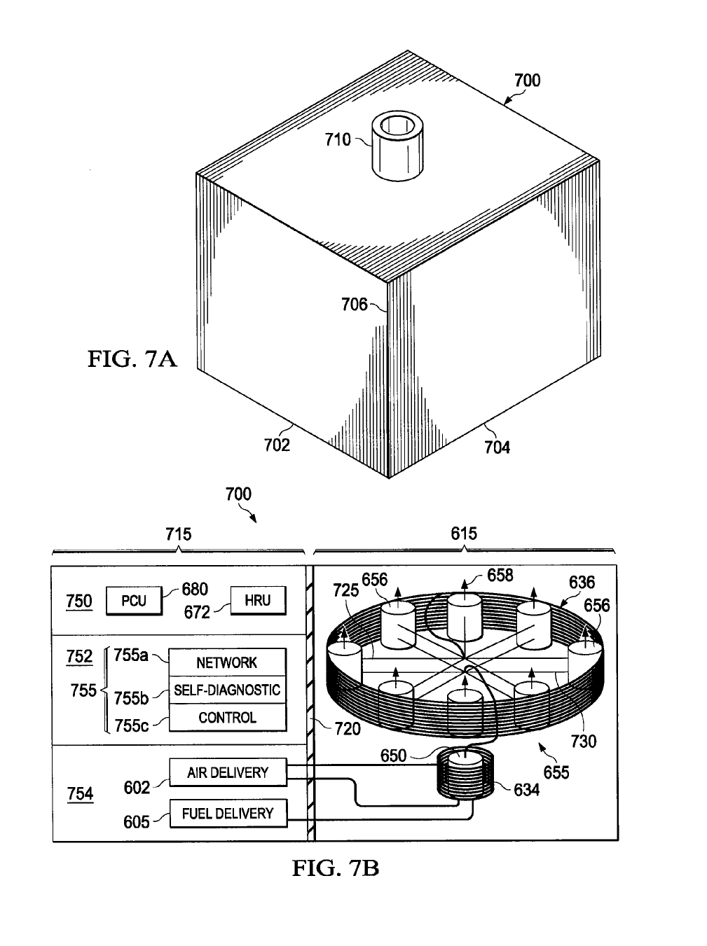

FIG. 8 is a flow diagram illustrating a method of operating a power generation system in accordance with one embodiment of the disclosure. In this embodiment, the power generation system is the power generation system 600 as implemented in the power generation unit 700. The power generation system 600 may be otherwise suitably operated. For example, the power generation system 600 may be operated with additional, fewer or disparate steps. Further, one or more of the steps may be combined, separated into separate steps, performed wholly or partially in parallel and/or otherwise suitably performed. The method may stay in and/or transition from and/or transition to a different step and/or mode at different conditions or based on disparate criteria. In addition, other power generation systems comprising of other types of reformer or fuel cell and/or a disparate configuration may so operated.

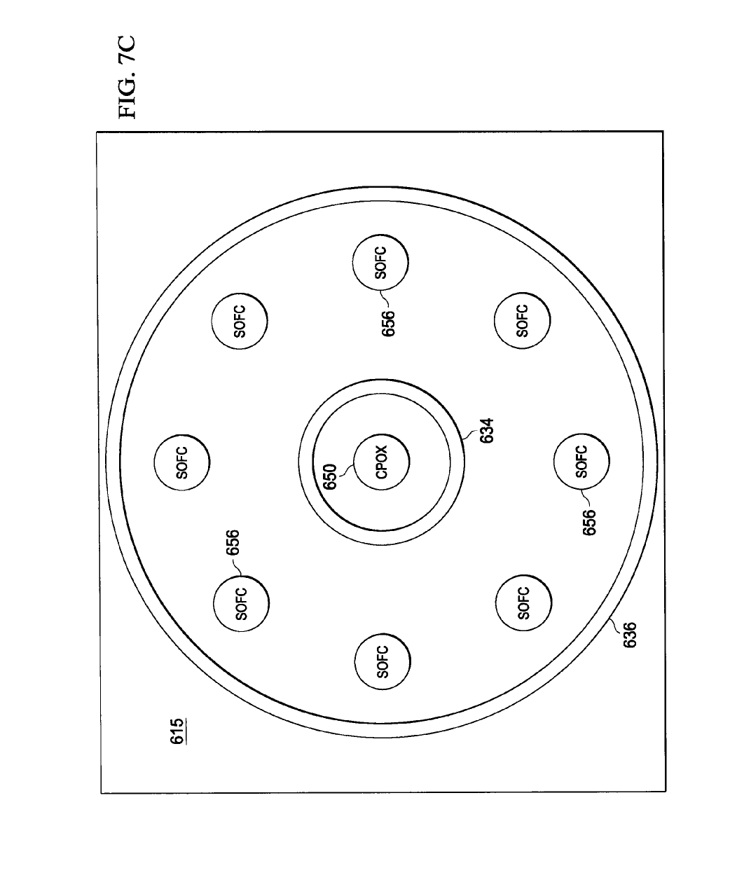

Referring to FIG. 8, the method begins at step 800 in which the power generation system 600 enters start-up mode. As described in more detail below in connection with FIG. 9, the control system 755 of the power generation system 600 may start the Pilot/Afterburner 660 and the HRU 672 in the start-up mode. In addition, the control system 755 may perform various checks and run diagnostics on various elements of the power generation 600 during start-up mode.

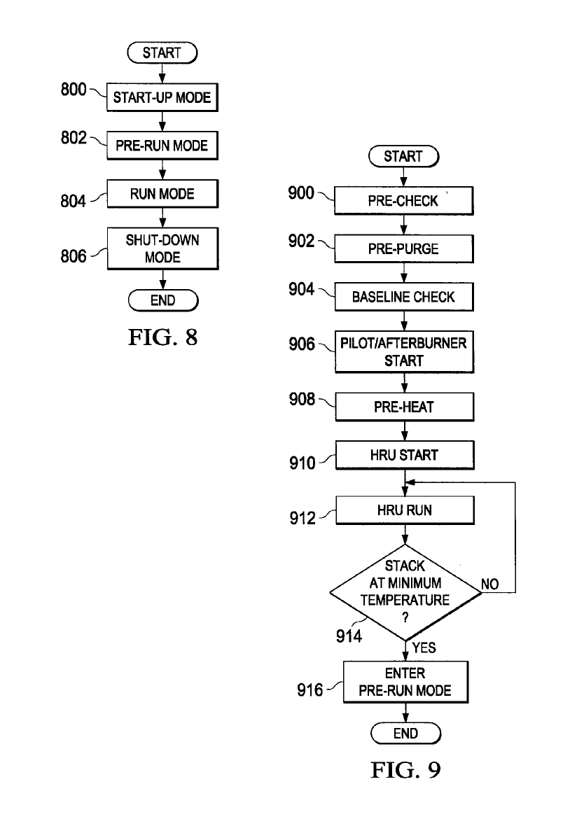

Next, at step 802, after successful completion of start-up mode, the power generation system 600 may enter the pre-run mode. As described in more detail below in connection with FIG. 10, the control system 755 may in the pre-run mode start the CPOx 650 and the hot box burner and ramp up temperatures in the hot box 615 to a steady state.

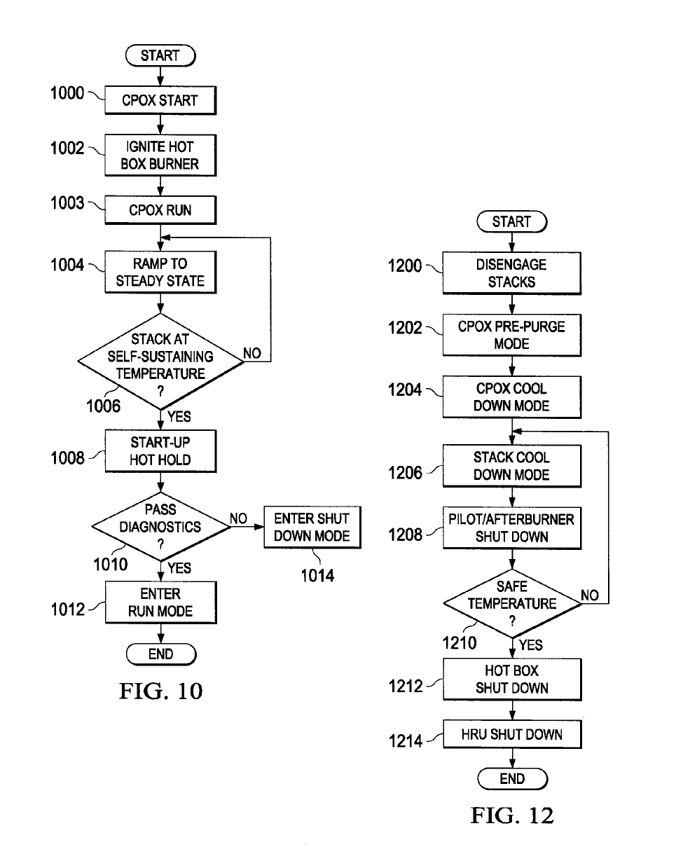

At step 804, the power generation system 600 enters the run mode. In a particular embodiment, when the temperature of the hot box 615 reaches a minimum self-sustaining temperature, the power generation system 600 may go into a hot hold state and enter the run mode. In the run mode, as described in more detail below in connection with FIG. 11, the power generation system 600 may operate at hot hold as a baseline and initiate load following. In a particular embodiment, the PCU 680 may monitor the output power requirements and the control system will adjust the fuel and air flows in the air and fuel delivery systems 602 and 605, in the fuel processing system 606 and/or in the fuel cell system 608 to meet demands for internal and/or output power.

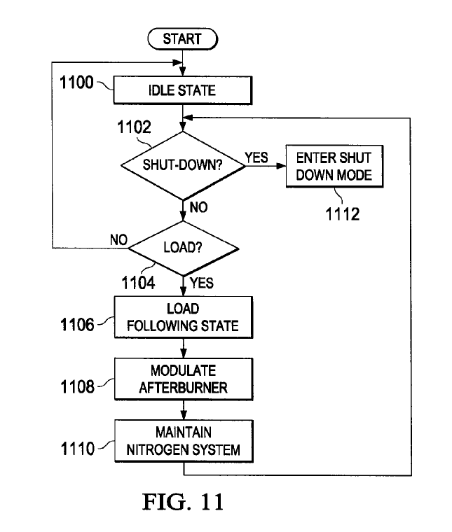

In response to a shut-down event, the power generation system 600 may enter shut-down mode at step 806. As described in more detail below in connection with FIG. 12, in the shut-down mode the CPOx 650, SOFCs 656 and HRU 672 may be gradually cooled and then shut down. In addition, the CPOx 650 and SOFCs 656 may be purged using the purging system 618 to prevent damage to the power generation system 600.

FIG. 9 is a flow diagram illustrating a method for performing the start-up mode of FIG. 8 in accordance with one embodiment of the disclosure. In this embodiment, the control system 755 may perform start-up mode steps either directly or indirectly by controlling other devices. The start-up mode may include additional, fewer or disparate steps. In addition, one or more of the steps may be combined, separated into separate steps and/or performed in a different order or wholly or partially in parallel. The method may stay in and/or transition from and/or transition to a different step and/or mode at different conditions or based on disparate criteria. Further, one or more or all of the steps may be performed by other elements and/or systems of the power generation system 600.

Referring to FIG. 9, the start-up mode begins at step 900 with a pre-check of the power generation system 600. In one embodiment, the control system 755 performs the pre-check by performing a self-diagnostic procedure and checking all the sensors and electrical components for correct range and operation.

Next, at step 902, the control system 755 performs a pre-purge of the power generation system 600. In one embodiment, the control system 755 performs the pre-purge by starting the blower 622 which blows ambient air through the power generation system 600 to exhaust any fumes that may have accumulated in the power generation system 600. In one embodiment, the pre-pure may last for approximately one minute.

At step 904, a baseline check is performed by the control system 755. In one embodiment, one, more or all pressure, temperature and flow sensor readings are logged for an operational baseline at the baseline check. Next, at step 906, the control system 755 starts the Pilot/Afterburner 660. In one embodiment, the control system 755 activates the Pilot/Afterburner igniter and opens Pilot/Afterburner air control valve 632 and Pilot/Afterburner fuel control valve 644. The Pilot/Afterburner igniter ignites the mixture in the Afterburner 660 to begin preheating the CPOx and components in the hot box 615.

Proceeding to step 908, the power generation system 600 enters a start-up pre-heat mode. In the preheat mode, the control system 755 may open the cathode air control valve 628 and the CPOx air valve 630 to allow air to flow through the primary and second heat exchangers 634 and 636 and the CPOx 650 to collect heat from the pilot/afterburner and preheat air entering the SOFCs 656. Air flow in cathode air control valve 628 and in the CPOx air control valve 630 may be adjusted to balance the temperatures entering the cathodes and anodes of SOFC's 656, respectively.

At step 910, the control system 755 may start the HRU system 614 including the HRU 672. In one embodiment, the control system 755 monitors hot box 615 exhaust temperatures during pre-heat and engages the HRU 672 when the hot box 615 reaches minimum required temperatures. As the HRU 672 begins to produce power, the control system 755 may engage the PCU 680 to convert the power from the HRU 672 to supply the internal, or parasitic, loads within the power generation system 600. The control system 755 may then take the start-up battery 160 (FIG. 1) off-line and recharge the start-up battery 160. In another embodiment, the control system 755 monitors Pilot/Afterburner exhaust temperature 662 during pre-heat and engages the HRU 672 when the temperatures at 662 and/or 664 reach minimum required temperatures.

Next, at step 912, the HRU 672 may enter run mode. As the hot box 615 exhaust temperatures and/or Pilot/afterburner exhaust temperature 662 and/or exhaust temperature 664 increase, the power from the HRU 672 also increases. When the HRU 672 power output exceeds the internal loads of the power generation system 600, the PCU 682 may maintain power for the internal loads and divert the excess power for an external, or customer, load.

Next, at decisional step 914, if the SOFCs 656 have not reached a minimum temperature, the No branch returns to step 912 and stack temperatures continue to increase with the HRU 672 in run mode. When temperature of the SOFCs 656 reach a minimum or other suitable level, the Yes branch of decisional step 914 leads to step 916 in which the power generation system 600 exits the start-up mode and enters the pre-run mode. In one embodiment, the minimum required temperature to enter pre-run mode is 400° C. The minimum required temperature may be other suitable temperatures. In addition, other or additional criteria may be used to transition from the start-up mode to the pre-run mode.

FIG. 10 is a flow diagram illustrating a method for performing the pre-run mode of FIG. 8 in accordance with one embodiment of the disclosure. In this embodiment, the control system 755 may perform the pre-run mode steps either directly or indirectly by controlling other devices. The pre-run mode may include additional, fewer or disparate steps. In addition, one or more of the steps may be combined, separated into separate steps performed wholly or partially in parallel and/or performed in a different order. The method may stay in and/or transition from and/or transition to a different step and/or mode at different conditions or based on disparate criteria. Further, one or more or all of the steps may be performed by other elements and/or systems of the power generation system 600.

Referring to FIG. 10, the pre-run mode begins at step 1000 with the CPOx start mode. In a particular embodiment, the control system 755 monitors temperatures in the SOFCs 656. When temperatures in the SOFCs 656 and CPOx have reached a pre-set level, the control system 755 activates the CPOx igniter, opens the CPOx fuel value 648 and adjusts air flow through CPOx air control valve 630 at step 1000 to ignite the mixture in the CPOx and complete pre-heating the CPOx.

Next, at step 1002, the control system 755 may ignite the hot box burner 681. In a particular embodiment, the control system 755 may activate the hot box burner 681, adjust the afterburner/pilot air control valve 632 and afterburner/pilot fuel control valve 644 to ensure complete combustion or substantially complete combustion in the exhaust and hot box 615 until steady state conditions in the power generation system 600 and/or the hot box 615 are achieved.

At step 1003, when the fuel cell stack and CPOx temperatures reach a pre-set level, the CPOx air valve 630 is reduced to initiate fuel production for the fuel cell stacks.

At step 1004, the power generation system 600 may be ramped to a steady state. In a particular embodiment, as fuel and air are utilized in the SOFCs 656, heat given off by the stacks 656 overcomes the temperature drop in the CPOx 650 and the hot box 615 temperatures continue to increase until steady state conditions are achieved.

Next, at decisional step 1006, the control system 755 may determine if the SOFCs 656 have reached a self-sustaining temperature. If the self-sustaining temperature is not yet reached in the SOFCs 656, the No branch of decisional step 1006 returns to step 1004 where the power generation system 600 continues to ramp to steady state. When the SOFCs 656 reach the self-sustaining temperature, the Yes branch of decisional step 1006 leads to step 1008.

At step 1008, the power generation system 600 may enter start-up hot hold. When entering start-up hot hold, extensive self-diagnostics routines may be run at decisional step 1010 to verify all systems are operating normally and/or operating at an acceptable level. If all systems are operating normally, the Yes branch of decisional step 1010 may lead to step 1012 where the power generation system 600 enters run mode. If all or one or more systems are not operating normally and/or are operating below a threshold level, the No branch of decisional step 1010 may lead to step 1014 where the power generation system 600 enters shut-down mode. Alternatively for example, the power generation system 600 may maintain at hot hold and the control system 755 communicate an error message to a remote monitoring and control station via the network 755a to allow corrective action. If the error can be remotely fixed, the power generation system 600 may then and/or after completing additional or repeating previous steps enter run mode without first shutting down.

FIG. 11 is a flow diagram illustrating a method for performing the run mode of FIG. 8 in accordance with one embodiment of the disclosure. In this embodiment, the control system 755 may perform the run mode steps either directly or indirectly by controlling other devices. The run mode may include additional, fewer or disparate steps. In addition, one or more of the steps may be combined, separated into separate steps, performed wholly or partially in parallel and/or performed in a different order. The method may stay in and/or transition from and/or transition to a different step and/or mode at different conditions or based on disparate criteria. Further, one or more or all of the steps may be performed by other elements and/or systems of the power generation system 600.

Referring to FIG. 11, the method begins at step 1100 wherein the power generation system 600 is in an idle state of the run mode. In a particular embodiment, the CPOx 650 and SOFCs 656 may be at hot hold when the power generation system 600 is in the run mode idle state. In this embodiment, the SOFCs may be generating power for internal use but not providing power to a load. In this mode, the system is in an idle state (i.e., where the system produces zero net power), where power will be used for the PCU, internal (parasitic) loads, and battery charging only. Once the stacks are up to temperature and are starting to enter their peak performance, then a command from the control unit can be issued to move to the run mode. A hot hold mode is where the power generation system produces 0 (zero) gross power and the batteries are supplying all power to the parasitics.

At any point while in the run mode idle state, if a shut-down event occurs, the Yes branch of decisional step 1102 leads to step 1112 where the power generation system 600 enters the shut-down mode. A shut-down event may comprise, for example, detection of a fault in the power generation system 600, failure of a critical or other element, system or unit of the power generation system 600 failure of a component or system to pass self-diagnostics and/or a request from the control system 755 if, for example, an external shut down command is received. In one embodiment, in response to a shut-down event, the power generation system 600 may remain in its current state to allow an operator at a remote station to correct the fault without entering shut-down mode. If a shut-down event has not occurred, the No branch of decisional step 1102 leads to decisional step 1104.

At decisional step 1104, the control system 755 may determine if there is a requirement for output power. If at any time there is a requirement for output power, the Yes branch of decisional step 1104 leads to step 1106. If there remains no requirement for output power for a load, the No branch of decisional step 1104 returns to idle state at step 1100.

At step 1106, the control system 755 may monitor the output power requirements of the load (via PCU 680 or otherwise) and adjusts fuel and air flows accordingly in the power generation system 600 to meet load demands for output power. While in the load following state, the control system 755 additionally modulates the afterburner/pilot 660 at step 1108. In particular, the afterburner/pilot output 662 may be modulated between off and full output to maintain the hot box 615 temperature and to ensure sufficient heat is supplied to the HRU 672 while the unit is in hot hold.

At step 1110, the control system 755 maintains the nitrogen purge system 618. In a particular embodiment, the control system 755 may start the air compressor 690 and nitrogen generator 692 and collect generated nitrogen in the storage tank 694. Storage tank pressure may be continuously monitored via pressure sensor P8 and the air compressor 690 and nitrogen generator 692 deactivated when the storage tank 694 is full or reaches a suitable level. Step 1100 returns to decisional step 1102 and the power generation system 600 remains in the load following state until occurrence of a shut-down event at step 1102 or the removal of the load at decisional step 1104.

FIG. 12 is a flow diagram illustrating a method for performing the shut-down mode of FIG. 8 in accordance with one embodiment of the disclosure. In this embodiment, the control system 755 may perform the shut-down mode steps either directly or indirectly by controlling other devices. The shut-down mode may include additional, fewer or disparate steps. In addition, one or more of the steps may be combined, separated into separate steps, performed wholly or partially in parallel and/or performed in a different order. The method may stay in and/or transition from and/or transition to a different step and/or mode at different conditions or based on disparate criteria. Further, one or more or all of the steps may be performed by other elements and/or systems of the power generation system 600.

Referring to FIG. 12, the method begins at step 1200 in which the SOFCs 656 may be disengaged. In one embodiment, the control system 755 may electrically disengage the SOFCs 656 from the PCU system 616. At step 1202, the CPOx 650 may enter pre-purge mode. In one embodiment, the control module 755 may adjust the air and fuel flow to the CPOx 650 via CPOx air and fuel control valves 630 and 648 to maintain a fuel rich mixture in the CPOx 650 to maintain a reducing environment for the anodes of the SOFCs 656 while maintaining cathode and anode inlet temperatures in the stack.

Next, at step 1204, the CPOx 650 may enter cool down mode. In a particular embodiment, the control module 755 may adjust the cathode air via control valve 628 to control air flow through the primary and second heat exchangers 634 and 636 to collect residual heat from the CPOx 650 and gradually cool down the air entering the cathodes of the SOFCs 656. In this embodiment, SOFC air and CPOx fuel flows through control valves 628 and 648 may be adjusted to balance the temperatures entering the cathodes and anodes of the SOFCs 656 while simultaneously or otherwise reducing temperatures in the hot box 615. Flow of air through CPOx air control valve 630 may be controlled to maintain a reducing environment on the stack anodes.

At step 1206, the SOFCs may be cooled down. In a particular embodiment, the control module 755 may adjust the cathode air control valve 628 which flows through the primary and second heat exchangers 634 and 636 to continue to collect residual heat from the CPOx 650 and gradually cool down the balance of plant. The control module 755 may also close CPOx air control valve 630 and CPOx fuel control valve 648 to stop reactions in the CPOx 650. During the stack cool down, the control system 755 may open the purge control valves 696 and 698 to purge the CPOx 650 and the SOFC 656 with accumulated nitrogen from the nitrogen storage tank 694. If the nitrogen storage tank 694 is omitted, the nitrogen compressor 690 and generator 692 may operate to provide nitrogen for the purge. Other suitable fluids may be used for purging. The purge may protect the catalyst in the CPOx 650 the anodes in the SOFCs 656 and/or other elements of these or other components from oxidation and prevent or limit formation of nickel carbonyl. HRU power can be also used during cool down mode to galvanically protect the fuel cell anodes from oxidation until a safe temperature is achieved.

Next, at step 1208, the afterburner/pilot 660 may be shut-down. In a particular embodiment, the control module 755 may deactivate the pilot igniter of the afterburner/pilot 660 and close afterburner/pilot air control valve 632 and afterburner/pilot fuel control valve 644 to the afterburner pilot 660.

Proceeding to decisional step 1210, if the hot box 615 has not yet reached a safe temperature, the No branch returns to step 1208 where cool down of the SOFC stack continues. When the hot box 615 has reached the safe or other suitable temperature, the Yes branch of decisional step 1210 leads to step 1212. At step 1212, the hot box 615 may be shut down. In some implementations, the control system 755 turns off air compressor 622, closes the cathode air valve 628 and closes the purge valves 696 and 698. Next, at step 1214, the HRU 672 is shut down by the control system 755. Step 1214 leads to the end of the shut-down mode by which the power generation system 600 is safely shut down from operation.

In some implementations, the hot box 615 can have a different layout from the stack exhaust to the power generation system 600 exhaust. The cathode exhaust and anode exhaust exiting the stack array 655 can be directly piped to the pilot/afterburner 660. With this configuration, no gases are exhausted directly into the hot box 615. In these implementations, the HRU set up can change, in that the first heat exchanger 670 of the HRU 614 can pick up excess heat from the hot box and the second heat exchanger 671 can pick up excess heat via heat exchange with the pilot/afterburner exhaust stream 662. This exchange includes radiative, convective and conductive heat exchange. After this heat exchange, the exhaust exits the hot box through the exhaust pipe 664. The hot box can be equipped with a secondary burner, i.e., the hot box burner 681, which functions to ensure complete combustion of any residual hydrogen, carbon monoxide or other fuel species prior to being exhausted from the power generation system 600.

In these implementations, a portion of the anode exhaust stream (i.e., a portion of the anode exhaust included in exhaust stream 658, which stream 658 generally includes both anode and cathode exhaust) can be redirected to the feed of the reformer 650 within the reformer subsystem 606. This is accomplished by various technologies, which can include eductor, ejector, venturi or other relevant components (shown as component 659). The anode recycle can accomplish two tasks. First, it can increase the flux of hydrogen and carbon monoxide within the anode side of the stacks 656, thus increasing the overall electrical efficiency of the power generation system 600. Second, it can provide the necessary water to allow internal reforming (steam reforming) to take place within the stack array 655, aiding in the thermal management required to keep the stacks at the optimal operating temperature. With having a fraction of the system fuel (of fuel system 605) pre-reformed in the reformer 650, the remainder is channeled to the stack, where it is steam reformed to the desired hydrogen and carbon monoxide constituents.

During shut down mode while the anode inlet temperature is above approximately 400° C., a portion of the electrical power generated by the HRU 118 can be returned to the fuel cell stack array 108 in order to galvanically protect against the oxidation of the anodes in the fuel cells 109. This process may or may not be used in conjunction with nitrogen from the purge system 618.

A number of embodiments of the invention have been described. Nevertheless, it will be understood that various modifications may be made without departing from the spirit and scope of the invention. Accordingly, other embodiments are within the scope of the following claims.

1. A power generation system, comprising:
a partial oxidation (POX) reactor operable to generate a hydrogen rich gas from a fuel;
an array of one or more fuel cell stacks, each fuel cell stack comprising at least one solid oxide fuel cell (SOFC), the array of fuel cell stacks coupled to the POX reactor and operable to generate electrical power and heat from an electro-chemical reaction of the hydrogen rich gas and oxygen from an oxygen source; and
a heat recovery unit (HRU) coupled to the array of fuel cell stacks, the HRU operable to generate electrical power from the heat.

2. The power generation system of claim 1, the partial oxidation reactor comprising a catalytic partial oxidation reactor (CPOx).

3. The power generation system of claim 1, where heat generated by the array of fuel cell stacks includes radiant heat generated by the one or more fuel cell stacks and heat of combustion from exhaust gases produced by the one or more fuel cell stacks.

4. The power generation system of claim 1, where the POX reactor generates heat and where the HRU is further operable to generate electrical power from the heat generated by the array of fuel cell stacks and the heat generated by the POX reactor.

5. The power generation system of claim 1, the HRU comprising a thermoelectric HRU.

6. The power generation system of claim 1, the HRU comprising a microturbine HRU.

7. The power generation system of claim 1, the HRU comprising a Stirling engine HRU.

8. The power generation system of claim 1, the HRU comprising a Rankine cycle HRU.

9. The power generation system of claim 1, the fuel comprising natural gas.

10. The power generation system of claim 1, the fuel comprising methane or propane.

11. The power generation system of claim 1, each fuel cell stack comprising a plurality of SOFCs.

12. The power generation system of claim 1, the POX reactor arranged within a thermal zone of the array of fuel cell stacks.

13. The power generation system of claim 12, where the array of fuel cell stacks comprises a plurality of fuel cell stacks and the POX reactor is arranged within an area bounded by the plurality of fuel cell stacks.

14. The power generation system of claim 1, the array of fuel cell stacks comprising eight fuel cell stacks.

15. The power generation system of claim 1, the oxygen source comprising air.

16. The power generation system of claim 1, the oxygen source comprising preheated air.

17. The power generation system of claim 1, further comprising a power conditioning unit (PCU) operable to receive and condition electrical power from the array of fuel cell stacks and the HRU and provide conditioned power to a load.

18. A power generation system, comprising:
a reformer reactor operable to generate a hydrogen rich gas from a fuel;
an array of one or more fuel cell stacks comprising at least one solid oxide fuel cell (SOFC), the array of fuel cell stacks coupled to the reformer reactor and operable to generate electrical power and heat from an electro-chemical reaction of the hydrogen rich gas and oxygen from an oxygen source; and
a heat recovery unit (HRU) coupled to the array of fuel cell stacks, the HRU operable to generate electrical power from the heat.

19. The power generation system of claim 18, where heat generated by the array of fuel cell stacks includes radiant heat generated by the one or more fuel cell stacks and heat of combustion from exhaust gases produced by the one or more fuel cell stacks.

20. The power generation system of claim 18, where the reformer reactor generates heat and where the HRU is further operable to generate electrical power from the heat generated by the array of fuel cell stacks and the heat generated by the reformer reactor.

21. The power generation system of claim 18, the reformer reactor comprising one of a steam reformer, an auto thermal reformer (ATR) or a water-independent reformer.

22. The power generation system of claim 21, where the water-independent reformer comprises a partial oxidation (POX) reactor.

23. The power generation system of claim 22, where the POX reactor comprises a catalytic partial oxidation (CPOx) reactor.

24. The power generation system of claim 18, the HRU comprising a thermoelectric HRU.

25. The power generation system of claim 18, the HRU comprising a microturbine HRU.

26. The power generation system of claim 18, the HRU comprising a Stirling engine HRU.

27. The power generation system of claim 18, the HRU comprising a Rankine cycle HRU.

28. The power generation system of claim 18, the fuel comprising natural gas.

29. The power generation system of claim 18, the fuel comprising methane or propane.

30. The power generation system of claim 18, each fuel cell stack comprising a plurality of SOFCs.

31. The power generation system of claim 18, the reformer reactor arranged within a thermal zone of the array of fuel cell stacks.

32. The power generation system of claim 31, where the array of fuel cell stacks comprises a plurality of fuel cell stacks and the reformer reactor is arranged within an area bounded by the plurality of fuel cell stacks.

33. The power generation system of claim 18, the array of fuel cell stacks comprising eight fuel cell stacks.

34. The power generation system of claim 18, the oxygen source comprising air.

35. The power generation system of claim 18, the oxygen source comprising preheated air.

36. The power generation system of claim 18, further comprising a power conditioning unit (PCU) operable to receive and condition electrical power from the array of fuel cell stacks and the HRU and to provide conditioned power to a load.

37. A power generation system, comprising:
a hydrogen rich gas source;
an array of one or more fuel cell stacks comprising at least one solid oxide fuel cell (SOFC), the array of fuel cell stacks coupled to the hydrogen rich gas source and operable to generate electrical power and heat from an electro-chemical reaction of the hydrogen rich gas and oxygen from an oxygen source;
a heat recovery unit (HRU) coupled to the array of fuel cell stacks, the HRU operable to generate electrical power from the heat.

38. The power generation system of claim 37, wherein the HRU comprises one of a thermoelectric HRU, a microturbine HRU, a Stirling engine HRU, or a Rankine cycle HRU.

39. The power generation system of claim 37, where heat generated by the array of fuel cell stacks includes radiant heat generated by the one or more fuel cell stacks and heat of combustion from exhaust gases produced by the one or more fuel cell stacks.

40. The power generation system of claim 37, the fuel comprising natural gas.

41. The power generation system of claim 37, the fuel comprising methane or propane.

42. The power generation system of claim 37, each fuel cell stack comprising a plurality of SOFCs.

43. The power generation system of claim 37, further comprising:
a partial oxidation (POX) reactor arranged within a thermal zone of the array of fuel cell stacks.

44. The power generation system of claim 42, where the POX reactor generates heat and where the HRU is further operable to generate electrical power from the heat generated by the array of fuel cell stacks including the heat of combustion from exhaust gases and the heat generated by the POX reactor.

45. The power generation system of claim 42, where the POX reactor comprises a catalytic partial oxidation (CPOx) reactor.

46. The power generation system of claim 37, wherein the array of fuel cell stacks comprises a plurality of fuel cell stacks and the POX reactor is arranged within an area bounded by the plurality of fuel cell stacks.

47. The power generation system of claim 37, the array of fuel cell stacks comprising eight fuel cell stacks.

48. The power generation system of claim 37, the oxygen source comprising air.

49. The power generation system of claim 37, further comprising a power conditioning unit (PCU) operable to receive and condition electrical power from the array of fuel cell stacks and the HRU and provide conditioned power to a load.

50. A power generation system, comprising:
a power generation module, the module comprising:
a partial oxidation (POX) reactor operable to generate a hydrogen rich gas from a fuel;
an array of one or more fuel cell stacks, each fuel cell stack comprising at least one solid oxide fuel cell (SOFC), the array of fuel cell stacks coupled to the POX reactor and operable to generate electrical power and heat from an electro-chemical reaction of the hydrogen rich gas and oxygen from an oxygen source and provide the power to a load; and
a heat recovery unit (HRU) coupled to the array of fuel cell stacks, the HRU operable to generate electrical power from the heat including the heat of combustion of exhaust gases and provide the power to the load.

51. The power generation system of claim 50, further comprising:
one or more additional power generation modules, where the power generation modules together provide power to the load.

52. A method for generating electrical power for a load, comprising:
generating a hydrogen rich gas from a fuel by partially combusting a fuel in a partial oxidation (POX) reactor;
providing the hydrogen rich gas to an array of one or more fuel cell stacks;
providing oxygen to the array of fuel cell stacks;
generating electrical power for a load and heat in the array of fuel cell stack by oxidizing the hydrogen rich gas with oxygen using a solid oxide electrolyte; and
recovering heat generated by the array of fuel cell stacks and using the heat to generate electrical power for the load.

53. The method of claim 52, where the POX reactor comprises a catalytic partial oxidation (CPOx) reactor.

54. The method of claim 52, where recovering heat generated by the array of fuel cell stacks comprises recovering radiant heat generated by the one or more fuel cell stacks and heat of combustion from exhaust gases produced by the one or more fuel cell stacks.

55. The method of claim 52, further comprising recovering heat generated by the POX reactor and using the heat to generate electrical power for the load.

56. The method of claim 52, further comprising:
recovering heat generated by the array of fuel cell stacks and using the heat to generate electrical power for the load using a thermoelectric HRU.

57. The method of claim 52, further comprising:
recovering heat generated by the array of fuel cell stacks and using the heat to generate electrical power for the load using a microturbine HRU.

58. The method of claim 52, further comprising:
recovering heat generated by the array of fuel cell stacks and using the heat to generate electrical power for the load using a Stirling engine HRU.

59. The method of claim 52, further comprising:
recovering heat generated by the array of fuel cell stacks and using the heat to generate electrical power for the load using a Rankine cycle HRU.

60. The method of claim 52, further comprising:
generating a hydrogen rich gas from a natural gas fuel by partially combusting the natural gas in a partial oxidation (POX) reactor.

61. The method of claim 52, further comprising:
generating a hydrogen rich gas from a methane fuel by partially combusting the methane or propane in a partial oxidation (POX) reactor.

62. The method of claim 52, further comprising:
treating air to provide the oxygen to the solid oxide electrolyte.

63. The method of claim 62, where treating the air comprises preheating the air.

64. The method of claim 52, further comprising:
conditioning the electrical power and providing the conditioned power to the load.

65. The method of claim 52, where partially combusting the fuel in the POX reactor comprises partially combusting the fuel in the POX reactor in a thermal zone of the array of fuel cell stacks.

66. A method for generating electrical power for a load, comprising:
generating a hydrogen rich gas from a fuel by reforming a fuel in a reformer reactor;
providing the hydrogen rich gas to an array of one or more fuel cell stacks;
providing oxygen to the array of fuel cell stacks;
generating electrical power for a load and heat in the array of fuel cell stacks by oxidizing the hydrogen rich gas with oxygen using a solid oxide electrolyte; and
recovering heat generated by the array of fuel cell stacks and using the heat to generate electrical power for the load.

67. The method of claim 66, where recovering heat generated by the array of fuel cell stacks comprises recovering radiant heat generated by the one or more fuel cell stacks and heat of combustion from exhaust gases produced by the one or more fuel cell stacks.

68. The method of claim 66, further comprising recovering heat generated by the reformer reactor and using the heat to generate electrical power for the load.

69. The method of claim 66, the reformer reactor comprising one of a steam reformer, an auto thermal reformer (ATR) or a water-independent reformer.

70. The method of claim 69, where the water-independent reformer comprises a partial oxidation (POX) reactor.

71. The method of claim 70, where the POX reactor comprises a catalytic partial oxidation reactor (CPOx).

72. The method of claim 66, further comprising:
recovering heat exhausted by the array of fuel cell stacks and using the heat to generate electrical power for the load using a thermoelectric HRU.

73. The method of claim 66, further comprising:
recovering heat exhausted by the array of fuel cell stacks and using the heat to generate electrical power for the load using a microturbine HRU.

74. The method of claim 66, further comprising:
recovering heat exhausted by the array of fuel cell stacks and using the heat to generate electrical power for the load using a Stirling engine HRU.

75. The method of claim 66, further comprising:
recovering heat exhausted by the array of fuel cell stacks and using the heat to generate electrical power for the load using a Rankine cycle HRU.

76. The method of claim 66, further comprising:
generating a hydrogen rich gas from a natural gas fuel by reforming the natural gas in a reformer reactor.

77. The method of claim 66, further comprising:
generating a hydrogen rich gas from a methane or propane fuel by reforming the methane or propane in a reformer reactor.

78. The method of claim 66, further comprising:
treating air to provide the oxygen to the solid oxide electrolyte.

79. The method of claim 78, where treating the air comprises preheating the air.

80. The method of claim 66, further comprising:
conditioning the electrical power and providing the conditioned power to the load.

81. The method of claim 66, where reforming the fuel in the reformer reactor comprises reforming the fuel in the reformer reactor in a thermal zone of the array of fuel cell stacks.

82. A method for generating electrical power for a load, comprising:
providing a hydrogen rich gas to an array of one or more fuel cell stacks;
providing oxygen to the array of fuel cell stacks;
generating electrical power for a load and heat in the array of fuel cell stacks by oxidizing the hydrogen rich gas with oxygen using a solid oxide electrolyte; and
recovering heat generated by the array of fuel cell stacks and using the heat to generate electrical power for the load.

83. A power generation system, comprising:
a partial oxidation (POX) reactor operable to generate a hydrogen rich gas from a fuel;
an array of one or more fuel cell stacks, each fuel cell stack comprising at least one solid oxide fuel cell (SOFC), the array coupled to the POX reactor and operable to generate electrical power for a load from an electro-chemical reaction of the hydrogen rich gas and oxygen from an oxygen source; and
a power conditioning unit (PCU) operable to receive and condition electrical power from the array of fuel cell stacks and provide at least 3 kW power to the load.

84. The power generation system of claim 83, where the partial oxidation reactor comprises a catalytic partial oxidation (CPOx) reactor.

85. The power generation system of claim 83, further comprising the power conditioning unit (PCU) operable provide at least 5 kW power to the load.

86. The power generation system of claim 83, further comprising the power conditioning unit (PCU) operable provide at least 7 kW power to the load.

87. The power generation system of claim 83, further comprising the power conditioning unit (PCU) operable provide at least 10 kW power.

88. The power generation system of claim 83, the fuel comprising natural gas.

89. The power generation system of claim 83, the fuel comprising methane or propane.

90. The power generation system of claim 83, each fuel cell stack comprising a plurality of SOFCs.

91. The power generation system of claim 83, the POX reactor arranged within a thermal zone of the array of fuel cell stacks.

92. The power generation system of claim 91, where the array of fuel cell stacks comprises a plurality of fuel cell stacks and the POX reactor is arranged within an area bounded by the plurality of fuel cell stacks.

93. The power generation system of claim 83, the array of fuel cell stacks comprising eight fuel cell stacks.

94. The power generation system of claim 83, the oxygen source comprising air.

95. The power generation system of claim 83, where the array of fuel cell stacks is further operable to generate heat, the power generation system further comprising:
a heat recovery unit (HRU) coupled to the array of fuel cell stacks and operable to generate electrical power from the heat and provide the power to the load.

96. The power generation system of claim 95, where heat generated by the array of fuel cell stacks includes radiant heat generated by the one or more fuel cell stacks and heat of combustion from exhaust gases produced by the one or more fuel cell stacks.

97. The power generation system of claim 95, where the POX reactor generates heat and where the HRU is further operable to generate electrical power from the heat generated by the array of fuel cell stacks and the heat generated by the POX reactor.

98. A power generation system, comprising:
a partial oxidation (POX) reactor operable to generate a hydrogen rich gas from a fuel; and
a plurality of fuel cell stacks arranged around the POX reactor and each fuel cell stack including at least one solid oxide fuel cell (SOFC), the plurality of fuel cell stacks coupled to the POX reactor and operable to generate electrical power for a load from an electro-chemical reaction of the hydrogen rich gas and oxygen from an oxygen source.

99. The power generation system of claim 98, where the POX reactor comprises a catalytic partial oxidation (CPOx) reactor.

100. The power generation system of claim 98, where the plurality of fuel cell stacks are each positioned substantially equidistant from the POX reactor.

101. The power generation system of claim 100, the plurality of fuel cell stacks comprising two fuel cell stacks.

102. The power generation system of claim 98, the plurality of fuel cell stacks comprising four fuel cell stacks.

103. The power generation system of claim 98, the plurality of fuel cell stacks comprising six fuel cell stacks.

104. The power generation system of claim 98, the plurality of fuel cell stacks comprising eight fuel cell stacks.

105. The power generation system of claim 98, the plurality of fuel cell stacks comprising five or more fuel cell stacks, where the fuel cell stacks are arranged in a substantially circular pattern around the POX reactor.

106. The power generation system of claim 98, the plurality of fuel cell stacks comprising five or more fuel cell stacks, where the fuel cell stacks are arranged in a substantially elliptical pattern around the POX reactor.

107. The power generation system of claim 98, the POX reactor arranged within a thermal zone of the plurality of fuel cell stacks.

108. The power generation system of claim 98, the oxygen source comprising an oxygen preheat system disposed in a thermal zone of the plurality of fuel cell stacks.

109. The power generation system of claim 108, the oxygen preheat system comprising a first preheater disposed in a thermal zone of the POX reactor and a second preheater disposed in a thermal zone of the plurality of fuel cell stacks.

110. The power generation system of claim 108, the oxygen preheat system comprising coils.

111. The power generation system of claim 108, the oxygen preheat system comprising a first preheater coil disposed in a thermal zone of the POX reactor and a second preheater coil disposed in a thermal zone of the plurality of fuel cell stacks.

112. The power generation system of claim 108, the oxygen preheat system comprising a shell and tubes.

113. The power generation system of claim 108, the oxygen preheat system comprising a plate and fins.

114. The power generation system of claim 98, the oxygen source operable to provide oxygen to each of the fuel cell stacks through a manifold at substantially a same temperature and pressure to each fuel cell stack.

115. The power generation system of claim 98, the oxygen source operable to provide oxygen to each of the fuel cell stacks through a manifold at substantially a same temperature and pressure and flow rate to each fuel cell stack.

116. The power generation system of claim 98, further comprising a power conditioning unit (PCU) operable to receive and condition electrical power from the plurality of fuel cell stacks and to provide conditioned power to the load.

117. The power generation system of claim 98, the fuel comprising natural gas.

118. The power generation system of claim 98, the fuel comprising propane or methane.

119. The power generation system of claim 98, the oxygen source comprising air.

120. The power generation system of claim 98, where the plurality of fuel cell stacks are further operable to generate heat, the power generation system further comprising:
a heat recovery unit (HRU) coupled to the plurality of fuel cell stacks and operable to generate electrical power from the heat and provide the power to the load.

121. The power generation system of claim 120, where heat generated by the plurality of fuel cell stacks includes radiant heat generated by the plurality of fuel cell stacks and heat of combustion from exhaust gases produced by the plurality of fuel cell stacks.

122. The power generation system of claim 120, where the POX reactor generates heat and where the HRU is further operable to generate electrical power from the heat generated by the plurality of fuel cell stacks and the heat generated by the POX reactor.

123. A power generation system, comprising:
a partial oxidation (POX) reactor operable to generate a hydrogen rich gas from a fuel;
a first heat exchanger disposed proximate to the POX reactor, the first heat exchanger operable to heat oxygen from an oxygen source to an intermediate level;
a plurality of fuel cell stacks, each fuel cell stack including at least one solid oxide fuel cell (SOFC), the plurality of fuel cell stacks arranged around the POX reactor;
a second heat exchanger proximate to the plurality of fuel cell stacks, the second heat exchanger operable to heat an oxygen source from the intermediate level to an operational level of the fuel cell stacks; and
the plurality of fuel cell stacks coupled to the POX reactor and operable to generate electrical power for a load from an electro-chemical reaction of the hydrogen rich gas and the oxygen heated to the operational level.

124. The power generation system of claim 123, where the POX reactor comprises a catalytic partial oxidation (CPOx) reactor.

125. The power generation system of claim 123, the plurality of fuel cell stacks comprising two fuel cell stacks.

126. The power generation system of claim 123, the plurality of fuel cell stacks comprising four fuel cell stacks.

127. The power generation system of claim 123, the plurality of fuel cell stacks comprising six fuel cell stacks.

128. The power generation system of claim 123, the plurality of fuel cell stacks comprising eight fuel cell stacks.

129. The power generation system of claim 123, the plurality of fuel cell stacks comprising at least five fuel cell stacks where the fuel cell stacks are arranged substantially in a circular pattern around the POX reactor.

130. The power generation system of claim 123, the POX reactor arranged within a thermal zone of the plurality of fuel cell stacks.

131. The power generation system of claim 123, the second heat exchanger disposed about a periphery of the plurality of fuel cell stacks.

132. The power generation system of claim 123, the first heat exchanger disposed about a periphery of the POX reactor.

133. The power generation system of claim 123, the first and second heat exchangers each comprising coils.

134. The power generation system of claim 123, the first and second heat exchangers each comprising a shell and tubes.

135. The power generation system of claim 123, the first and second heat exchangers each comprising a plate and fins.

136. The power generation system of claim 123, where the plurality of fuel cell stacks are further operable to generate heat, the power generation system further comprising:
a heat recovery unit (HRU) coupled to the plurality of fuel cell stacks and operable to generate electrical power from the heat and provide the power to the load.

137. The power generation system of claim 136, where heat generated by the plurality of fuel cell stacks includes radiant heat generated by the plurality of fuel cell stacks and heat of combustion from exhaust gases produced by the plurality of fuel cell stacks.

138. The power generation system of claim 136, where the POX reactor generates heat and where the HRU is further operable to generate electrical power from the heat generated by the plurality of fuel cell stacks and the heat generated by the POX reactor.

139. A power generation system comprising:
a partial oxidation (POX) reactor operable to generate a hydrogen rich gas from a fuel;
an array of one or more fuel cell stacks, each fuel cell stack comprising at least one solid oxide fuel cell (SOFC), the array coupled to the POX reactor and operable to generate electrical power for a load from an electro-chemical reaction of the hydrogen rich gas and oxygen from an oxygen source; and
a control unit operable to control a feed of hydrogen rich gas and a feed of oxygen to the array of fuel cell stacks to maintain a substantially constant output of power from the array of fuel cell stacks for at least 18 months.

140. The power generation system of claim 139, where the POX reactor comprises a catalytic partial oxidation (CPOx) reactor.

141. The power generation system of claim 139, wherein:
the control unit is further operable to monitor a voltage and current output from the array of fuel cell stacks and to control the feed of hydrogen rich gas based on the monitored voltage output to maintain the substantially constant output of power.

142. The power generation system of claim 141, wherein the control unit is further operable to monitor a voltage output from each of the fuel cell stacks in the array of fuel cell stacks and to control the feed of hydrogen rich gas to each fuel cell stack individually.

143. The power generation system of claim 139, wherein:
the control unit is further operable to monitor a voltage and current output from the array of fuel cell stacks to control the feed of oxygen based on the monitored current output to maintain the substantially constant output of power.

144. The power generation system of claim 143, wherein the control unit is further operable to monitor a current output from each of the fuel cell stacks in the array of fuel cell stacks and to control the feed of oxygen to each fuel cell stack individually.

145. The power generation system of claim 139, wherein:
the control unit is further operable to control a feed of hydrogen rich gas and a feed of oxygen to the array of fuel cell stacks to maintain a substantially constant output of power from the array of fuel cell stacks for at least 18 months.

146. The power generation system of claim 139, further comprising:
a heat recovery unit (HRU) coupled to the array of fuel cell stacks, the HRU operable to generate electrical power from heat recovered from the array of fuel cell stacks.

147. The power generation system of claim 146, where heat recovered from the array of fuel cell stacks includes radiant heat generated by the one or more fuel cell stacks and heat of combustion from exhaust gases produced by the one or more fuel cell stacks.

148. The power generation system of claim 146, where the POX reactor generates heat and where the HRU is further operable to recover heat from the array of fuel cell stacks and the POX reactor and to generate electrical power from the recovered heat.

149. The power generation system of claim 139, where the fuel comprises natural gas.

150. The power generation system of claim 139, where the fuel comprises methane or propane.

151. The power generation system of claim 139, where the array of fuel cell stacks comprises a plurality of fuel cell stacks and the POX reactor is positioned within a thermal zone of the plurality of fuel cell stacks.

152. The power generation system of claim 139, where the oxygen source comprises air.

153. The power generation system of claim 139, further comprising:
a power conditioning unit (PCU) operable to receive and condition electrical power from the array of fuel cell stacks and to provide the conditioned power to a load.

154. The power generation system of claim 139, further comprising:
a heat recovery unit (HRU) coupled to the array of fuel cell stacks, the HRU operable to generate electrical power from heat recovered from the array of fuel cell stacks;
where the PCU is operable to receive and condition electrical power received from the array of fuel cell stacks and the HRU.

155. A power generation system comprising:
a reformer reactor operable to generate a hydrogen rich gas from a fuel;
an array of one or more fuel cell stacks, each fuel cell stack comprising at least one electro-chemical fuel cell, the array coupled to the reformer reactor and operable to generate electrical power and heat from an electro-chemical reaction of the hydrogen rich gas and oxygen from an oxygen source; and
a controller operable to purge the reformer reactor and the array of fuel cell stacks with accumulated nitrogen to inhibit oxidation and the formation of nickel carbonyl on a catalyst in the reformer reactor and one or more fuel cells in the array of fuel cell stacks.

156. The power generation system of claim 155, further comprising:
a heat recovery unit (HRU) coupled to the array of fuel cell stacks, the HRU operable to generate electrical power from the heat recovered from the array of fuel cell stacks;
where the controller is further operable to direct electrical power from the HRU to the array of fuel cell stacks during a shutdown operation to inhibit oxidation in the array of fuel cell stacks.

157. The power generation system of claim 156, where heat recovered from the array of fuel cell stacks includes radiant heat generated by the one or more fuel cell stacks and heat of combustion from exhaust gases produced by the one or more fuel cell stacks.

158. The power generation system of claim 156, where the reformer reactor generates heat and where the HRU is further operable to recover heat from the array of fuel cell stacks and the reformer reactor and to generate electrical power from the recovered heat.

159. The power generation system of claim 156, where the HRU comprises a thermoelectric HRU.

160. The power generation system of claim 156, where the HRU comprises a microturbine HRU.

161. The power generation system of claim 156, where the HRU comprises a Stirling engine HRU.

162. The power generation system of claim 156, where the HRU comprises a Rankine cycle HRU.

163. The power generation system of claim 155, where the reformer reactor comprises a partial oxidation (POX) reactor.

164. The power generation system of claim 163, where the POX reformer reactor comprises a catalytic partial oxidation (CPOx) reactor.

165. The power generation system of claim 155, where the reformer reactor comprises a steam reformer.

166. The power generation system of claim 155, where the reformer reactor comprises an autothermal reformer.

167. The power generation system of claim 155, where the reformer reactor comprises a water-independent reformer reactor.

168. The power generation system of claim 155, where at least one electro-chemical fuel cell comprises a solid oxide fuel cell (SOFC).

169. The power generation system of claim 155, where at least one electro-chemical fuel cell comprises a high temperature ceramic fuel cell.

170. The power generation system of claim 155, where the fuel comprises natural gas.

171. The power generation system of claim 155, where the fuel comprises methane or propane.

172. The power generation system of claim 155, where the array of fuel cell stacks comprises a plurality of fuel cell stacks and the reformer reactor is positioned within a thermal zone of the plurality of fuel cell stacks.

173. The power generation system of claim 155, where the oxygen source comprises air.

174. The power generation system of claim 155, further comprising:
a power conditioning unit (PCU) operable to receive and condition electrical power from the array of fuel cell stacks and to provide the conditioned power to a load.

175. A power generation system comprising:
a reformer reactor operable to generate a hydrogen rich gas from a fuel;
an array of one or more fuel cell stacks, each fuel cell stack comprising at least one electro-chemical fuel cell, the array operable to generate electrical power and heat from an electro-chemical reaction of the hydrogen rich gas and oxygen from an oxygen source;
a heat source operable to warm the array of fuel cell stacks during a start-up operation; and
a heat recovery unit (HRU) operable to generate electrical power from heat generated by the reformer reactor and the heat source within approximately 30 minutes of commencing the start-up operation.

176. The power generation system of claim 175, where the HRU is further operable to generate electrical power from the heat generated by the reformer reactor and the heat source within approximately 20 minutes of commencing the start-up operation.

177. The power generation system of claim 175, where the reformer reactor comprises a partial oxidation (POX) reactor.

178. The power generation system of claim 177, where the POX reactor comprises a catalytic partial oxidation (CPOx) reactor.

179. The power generation system of claim 175, where the heat source comprises a battery operated heater.

180. The power generation system of claim 175, where the heat source comprises a gas-operated heater.

181. The power generation system of claim 175, where the heat source includes heat generated by the reformer reactor.

182. The power generation system of claim 175, where the fuel comprises natural gas.

183. The power generation system of claim 175, where the fuel comprises methane or propane.

184. The power generation system of claim 175, where the HRU comprises a thermoelectric HRU.

185. The power generation system of claim 175, where the HRU comprises a microturbine HRU.

186. The power generation system of claim 175, where the HRU comprises a Stirling engine HRU.

187. The power generation system of claim 175, where the HRU comprises a Rankine cycle HRU.

188. The power generation system of claim 175, where the at least one electro-chemical fuel cell comprises a solid oxide fuel cell (SOFC).

189. The power generation system of claim 175, where the at least one electro-chemical fuel cell comprises a high temperature ceramic fuel cell.

190. The power generation system of claim 175, where the oxygen source comprises air.

191. The power generation system of claim 175, further comprising:
a power conditioning unit (PCU) operable to receive and condition electrical power from the array of fuel cell stacks and HRU and to provide the conditioned power to a load.

192. A power generation system comprising:
a reformer reactor operable independent of water to generate a hydrogen rich gas from a fuel;
an array of one or more fuel cell stacks, each fuel cell stack comprising at least one electro-chemical fuel cell, the array coupled to the reformer reactor and operable to generate electrical power and heat from an electro-chemical reaction of the hydrogen rich gas and oxygen from an oxygen source; and
a heat recovery unit (HRU) coupled to the array of fuel cell stacks and operable to generate electrical power from the heat generated by the array of fuel cell stacks.

193. The power generation system of claim 192, where the reformer reactor comprises a partial oxidation (POX) reactor.

194. The power generation system of claim 193, where the POX reactor comprises a catalytic partial oxidation (CPOx) reactor.

195. The power generation system of claim 192, where heat generated by the array of fuel cell stacks includes radiant heat generated by the one or more fuel cell stacks and heat of combustion from exhaust gases produced by the one or more fuel cell stacks.

196. The power generation system of claim 192, where the reformer reactor generates heat and where the HRU is further operable to recover heat from the array of fuel cell stacks and the reformer reactor and to generate electrical power from the recovered heat.

197. The power generation system of claim 192, where the array of fuel cell stacks comprises a plurality of fuel cell stacks and the reformer reactor is positioned within a thermal zone of the plurality of fuel cell stacks.

198. The power generation system of claim 192, where the at least one electro-chemical fuel cell comprises a solid oxide fuel cell (SOFC).

199. The power generation system of claim 192, further comprising a power conditioning unit (PCU) operable to receive and condition electrical power from the array of fuel cell stacks and the HRU and to provide the conditioned power to a load.

200. The power generation system of claim 192, where the fuel comprises natural gas.

201. The power generation system of claim 192, where the fuel comprises methane or propane.

202. The power generation system of claim 192, where the oxygen source comprises air.

203. The power generation system of claim 192, where the HRU comprises a thermoelectric HRU.

204. The power generation system of claim 192, where the HRU comprises a microturbine HRU.

205. The power generation system of claim 192, where the HRU comprises a Stirling engine HRU.

206. The power generation system of claim 192, where the HRU comprises a Rankine cycle HRU.

207. A power generation system comprising:
a reformer reactor operable to generate a hydrogen rich gas from a fuel;
an array of one or more fuel cell stacks, each fuel cell stack comprising at least one electro-chemical fuel cell, the array coupled to the reformer reactor and operable to generate electrical power and heat from an electro-chemical reaction of the hydrogen rich gas and oxygen from an oxygen source;
a heat recovery unit (HRU) coupled to the array of fuel cell stacks and operable to generate electrical power from the heat generated by the array; and
a controller operable to control operation of the power generation system, the controller including a self-diagnostic unit operable to detect a fault and to communicate the fault over a network to a remote location.

208. The power generation system of claim 207, where heat generated by the array of fuel cell stacks includes radiant heat generated by the one or more fuel cell stacks and heat of combustion from exhaust gases produced by the one or more fuel cell stacks.

209. The power generation system of claim 207, where the reformer reactor generates heat and where the HRU is further operable to recover heat from the array of fuel cell stacks and the reformer reactor and to generate electrical power from the recovered heat.

210. The power generation system of claim 207, where the electrical power output from the array of fuel cell stacks and the HRU is in the range of approximately 3 to 10 kilowatts.

211. The power generation system of claim 207, where the fault can be related to at least one of the following: a load on the power generation system, a current generated by the power generation system, a voltage generated by the power generation system, a flow rate of the fuel, a flow rate of the oxygen, a temperature measured within the power generation system, or a pressure measured within the power generation system.

212. The power generation system of claim 207, where the network comprises a telephone network.

213. The power generation system of claim 207, where the network comprises a radio network.

214. The power generation system of claim 207, where the network comprises a satellite network.

215. The power generation system of claim 207, further comprising:
one or more sensors included in the power generation system, where the one or more sensors are operable to communicate with the self-diagnostic unit.

216. The power generation system of claim 215, where the one or more sensors are wireless sensors.

217. The power generation system of claim 215, further comprising:
a remote control unit, where the remote control unit is operable to:
communicate with the controller over the network; and
transmit instructions to control operation of the power generation system to the controller over the network.

218. The power generation system of claim 207, further comprising:
a power conditioning unit (PCU) operable to receive and condition electrical power from the array of fuel cell stacks and the HRU and to provide the conditioned power to a load.
